(19) United States
(12) Patent Application Publication
(10) Pub. No.: US 2025/0330542 A1
(43) Pub. Date: Oct. 23, 2025

(54) STORAGE MEDIUM STORING PROGRAM THAT ALLOWS USER TO USE SHARPNESS ADJUSTMENT FUNCTION, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: ERI OKUDA, Ibaraki (JP)

(21) Appl. No.: 19/089,554

(22) Filed: Mar. 25, 2025

(30) Foreign Application Priority Data
Apr. 18, 2024 (JP) 2024-067463

(51) Int. Cl. H04N 1/00; H04N 1/40

(52) U.S. Cl. CPC H04N 1/00482; H04N 1/00421; H04N 1/0044; H04N 1/00824; H04N 1/40068; H04N 2201/0094

(57) ABSTRACT

A storage medium storing a program that allows a user to use a sharpness adjustment function is provided. A non-transitory computer-readable storage medium stores a program that supports a general purpose program that outputs an instruction capable of being commonly interpreted by scanners from a plurality of manufacturers, the program causing a computer to display a setting screen that accepts a setting for a sharpness adjustment of an image that has been read, and output a command for causing the scanner execute a scan processing in accordance with the setting that has been accepted on the setting screen.

### BACKGROUND OF THE INVENTION

### Field of the Invention

The present invention relates to a storage medium storing a program, a control method for an information processing apparatus, and an information processing apparatus.

### Description of the Related Art

There has been known a configuration in which a scan driver, which has been installed into a host computer as control software for controlling a scan apparatus, is used to instruct the scan apparatus that has been connected to the host computer to execute a scan processing. An operating system (hereinafter, referred to as “an OS”), which is basic software, has been installed into the host computer, and the scan driver is configured in accordance with the specifications defined by the OS and operates by being called out from the OS. A manufacturer that provides a scan apparatus is able to provide a scan driver that conforms to the specifications of an OS, thereby providing a means for instructing the scan apparatus to execute a scan processing by using the OS.

Meanwhile, Windows (registered trademark) is about to provide a standard class driver (hereinafter, also referred to as “a standard driver”) that is capable of being commonly used for scan apparatuses from a plurality of manufacturers. Such a standard driver is included in a package of the OS (has been bundled with the package of the OS), and becomes capable of being easily used by connecting any scan apparatus to the host computer. As a result, there is no need to separately install a model-specific scan driver suited to the scan apparatus, which is highly convenient. In addition, the standard driver is assumed to be configured to be capable of designating a scan function based on scan function information of the scan apparatus that has been connected to the host computer. As a result, a user who uses the standard driver is able to designate a scan function in accordance with capabilities of the scan apparatus that has been connected to the host computer, even though the user uses only one standard driver. However, this is limited to functions that are capable of being realized only with the standard driver, so manufacturer-specific functions are not capable of being designated. In order to deal with this issue, as a technique that allows the user to use the manufacturer-specific function, a technique disclosed in Japanese Laid-Open Patent Publication (kokai) No. 2021-033526 has been proposed. Japanese Laid-Open Patent Publication (kokai) No. 2021-033526 discloses a program that extends print functions of general purpose software.

Here, the manufacturer-specific functions include a sharpness adjustment function. The sharpness adjustment function is a function for adjusting the sharpness of an image that has been read (a scanned image). By scanning a document (an original) using the sharpness adjustment function, the user is able to obtain image data in which the outlines of characters and lines are clear, or image data in which the outlines of halftone dots in a halftone document (a halftone original) are blurred to reduce moire.

However, since the standard driver does not support the sharpness adjustment function, the host computer that uses the standard driver to instruct the scan apparatus to execute a scan processing is not able to allow the user to use the sharpness adjustment function.

### SUMMARY OF THE INVENTION

The present invention provides a storage medium storing a program that allows a user to use a sharpness adjustment function, a control method for an information processing apparatus, and an information processing apparatus.

Accordingly, the present invention provides a non-transitory computer-readable storage medium storing a program that supports a general purpose program that outputs an instruction capable of being commonly interpreted by scanners from a plurality of manufacturers, the program causing a computer to display a setting screen that accepts a setting for a sharpness adjustment of an image that has been read, and output a command for causing the scanner execute a scan processing in accordance with the setting that has been accepted on the setting screen.

According to the present invention, it is possible to allow the user to use the sharpness adjustment function. Further features of the present invention will become apparent from the

following description of exemplary embodiments with reference to the attached drawings.

### BRIEF DESCRIPTION OF THE DRAWINGS

FIG. 1 is a block diagram that schematically shows a hardware configuration of a communication system according to a first embodiment of the present invention.

FIG. 2A and FIG. 2B are block diagrams each schematically showing a software configuration for a host computer shown in FIG. 1 to instruct a scan apparatus shown in FIG. 1 to execute a scan processing.

FIGS. 3A, 3B, and 3C are diagrams that show examples of screens

displayed on a display unit shown in FIG. 1.

FIG. 4 is a flowchart that shows the procedure of an edit control processing executed by a scan function extending unit shown in FIG. 2B.

FIGS. 5A, 5B, and 5C are diagrams that show examples of various information used by the scan function extending unit shown in FIG. 2B.

FIG. 6 is a sequence diagram that shows the procedure of a scan control processing executed in the communication system shown in FIG. 1.

FIG. 7 is a flowchart that shows the procedure of a scan instruction command generation processing executed by an extended application shown in FIG. 2B.

FIG. 8 is a flowchart that shows the procedure of a control processing executed by the scan apparatus shown in FIG. 1.

FIG. 9 is a flowchart that shows the procedure of an edit control processing executed by a scan function extending unit according to a second embodiment.

FIG. 10 is a sequence diagram that shows the procedure of a scan control processing executed in a communication system according to the second embodiment.

FIG. 11 is a flowchart that shows the procedure of a scan instruction command generation processing executed by an extended application according to the second embodiment.

FIG. 12 is a sequence diagram that shows the procedure of a scan control processing executed in a communication system according to a third embodiment.

FIG. 13 is a sequence diagram that shows the procedure of a scan control processing executed in a communication system according to a fourth embodiment.

FIG. 14 is a sequence diagram that shows the procedure of a scan control processing executed in a communication system according to a fifth embodiment.

FIG. 15 is a flowchart that shows the procedure of a scan instruction command generation processing executed by an extended application according to the fifth embodiment.

FIGS. 16A, 16B, and 16C are diagrams that shows examples of capability information of a scan apparatus used in a communication system according to a sixth embodiment, an extended application supported function list and a detailed setting screen.

FIG. 17 is a sequence diagram that shows the procedure of a scan control processing executed in the communication system according to the sixth embodiment.

FIG. 18 is a flowchart that shows the procedure of a scan instruction command generation processing executed by an extended application according to the sixth embodiment.

FIG. 19A and FIG. 19B show a flowchart that shows another procedure of the scan instruction command generation processing executed by the extended application according to the sixth embodiment.

FIG. 20 is a diagram that shows an example of a detailed setting screen displayed on a display unit of a host computer according to a seventh embodiment.

FIG. 21 is a sequence diagram that shows the procedure of a scan control processing executed in a communication system according to the seventh embodiment.

FIG. 22 is a flowchart that shows the procedure of a scan instruction command generation processing executed by an extended application according to the seventh embodiment.

FIG. 23 is a sequence diagram that shows the procedure of a scan control

processing executed in a communication system according to an eighth embodiment.

FIG. 24 is a flowchart that shows the procedure of a scan instruction command generation processing executed by an extended application according to the eighth embodiment.

### DESCRIPTION OF THE EMBODIMENTS

The present invention will now be described in detail below with reference to the accompanying drawings showing embodiments thereof.

Hereinafter, embodiments of the present invention will be described in detail with reference to the accompanying drawings. It should be noted that each of the following embodiments does not limit the present invention as defined by the claims, and not all of the combinations of features described in each of the following embodiments are necessarily essential to the solving means of the present invention.

First, programs, a communication system, an information processing apparatus, and a control method for the information processing apparatus according to a first embodiment of the present invention will be described.

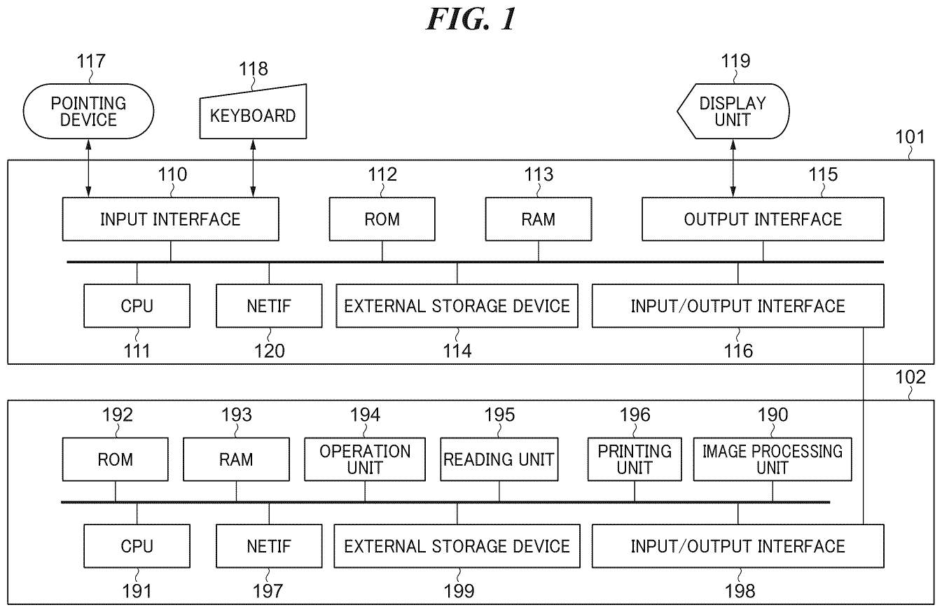

FIG. 1 is a block diagram that schematically shows a hardware configuration of the communication system according to the first embodiment. As shown in FIG. 1, the communication system according to the first embodiment includes a host computer 101 and a scan apparatus 102.

The host computer 101 is an example of an information processing apparatus, and includes an input interface 110, a central processing unit (a CPU) 111, a read only memory (a ROM) 112, a random access memory (a RAM) 113, an external storage device 114, an output interface 115, and an input/output interface 116. Input devices such as a keyboard 118 and a pointing device 117 are connected to the input interface 110, and a display device such as a display unit 119 is connected to the output interface 115. The host computer 101 further includes a NETIF 120. The NETIF 120 is a network interface, and performs control for carrying out data communication with an external device via a network (not shown).

The ROM 112 stores an initialization program. The external storage device 114 is, for example, a hard disk drive (an HDD) or a solid state drive (an SSD). The external storage device 114 stores an application program group (a group of application programs), an operating system (an OS), and other various kinds of data. The RAM 113 is used as a working memory or the like when executing the program that has been stored in the external storage device 114. It should be noted that in the first embodiment, the CPU 111 performs processing in accordance with codes of the programs that have been stored in the ROM 112, thereby executing functions of the host computer 101, which will be described below, and processing of the host computer 101 according to flowcharts, which will be described below.

The scan apparatus 102 is an example of an image processing apparatus, and is connected to the host computer 101 via an input/output interface 198 of the scan apparatus 102 and the input/output interface 116 of the host computer 101. The input/output interface 198 of the scan apparatus 102 and the input/output interface 116 of the host computer 101 may be connected via a wired network or a wireless network.

The scan apparatus 102 includes an image processing unit 190, a CPU 191, a ROM 192, a RAM 193, an operation unit 194, a reading unit 195, a printing unit 196, a NETIF 197, the input/output interface 198, and an external storage device

The CPU 191 comprehensively controls the scan apparatus 102. The ROM 192 is a memory that stores programs. The RAM 193 is a memory that temporarily stores programs and image data. The reading unit 195 is a scanner, and reads an image of a document and generates image data. The printing unit 196 prints an image on a sheet based on the image data. It should be noted that in the first embodiment, a configuration in which the scan apparatus 102 includes the printing unit 196 will be described, however, the configuration of the scan apparatus 102 is not limited to this configuration, and the scan apparatus 102 may not include the printing unit 196. The NETIF 197 is a network interface, and performs control for carrying out data communication with an external device via the network (not shown). The image processing unit 190 performs various kinds of image editing processes on the inputted image data.

It should be noted that although the host computer 101 and the scan apparatus 102 are shown as separate apparatuses in FIG. 1, the host computer 101 and the scan apparatus 102 may be configured as a single information processing apparatus. It should be noted that in the first embodiment, although the scan apparatus 102 will be described as an electrophotographic digital multifunction peripheral (an electrophotographic digital MFP) that has a plurality of functions such as copying, printing, and faxing, the scan apparatus 102 is not limited to a digital multifunction peripheral. The scan apparatus 102 may be, for example, an apparatus that uses another process such as an inkjet system, or a scanner that only performs reading an image. In addition, the host computer 101 may be a desktop type personal computer, a smartphone, or a notebook type personal computer.

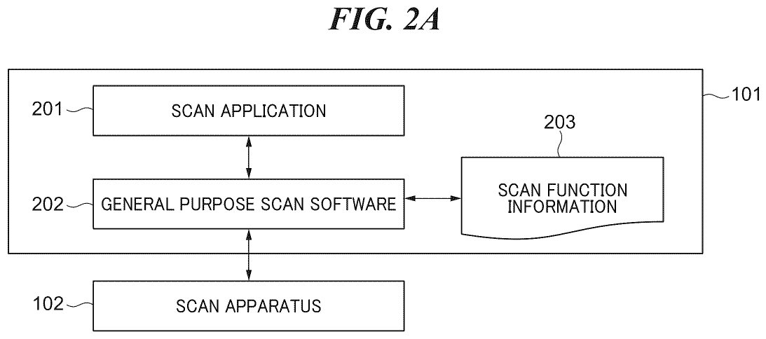

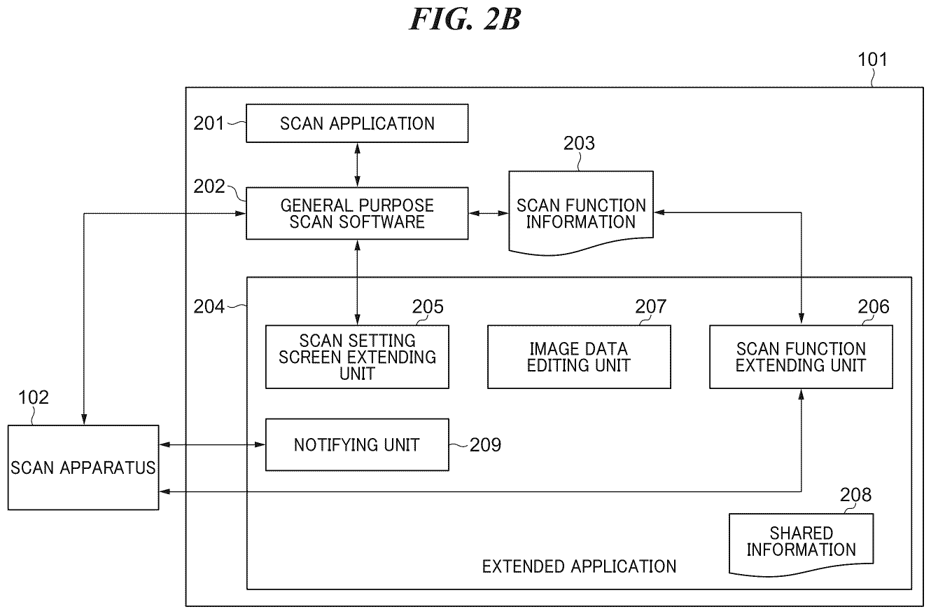

FIG. 2A and FIG. 2B are block diagrams each schematically showing a software configuration for the host computer 101 shown in FIG. 1 to instruct the scan apparatus 102 shown in FIG. 1 to execute a scan processing. It should be noted that in the first embodiment, as an example, the host computer 101 will be described as having Windows (registered trademark) 11 by Microsoft (registered trademark) installed as its OS.

FIG. 2A shows a software configuration for the host computer 101 that does not include an extended application 204 to instruct the scan apparatus 102 to execute a scan processing.

As shown in FIG. 2A, the host computer 101 includes a scan application 201 and general purpose scan software 202 as software for instructing the scan apparatus 102 to execute a scan processing. The processes performed by these software are realized by the CPU 111 executing programs that have been stored in the external storage device 114. In addition, the host computer 101 includes scan function information 203.

The scan application 201 is software that imports contents (image data) generated by scanning a document (an original), and is, for example, a document creation application or an image editing application. When the scan application 201 receives a scan request from a user, the scan application 201 issues a scan instruction to the OS of the host computer 101. The scan instruction includes scan setting information for instructing the operations of the general purpose scan software 202 and the scan apparatus 102.

As a screen for accepting a scan request from a user, a scan setting screen

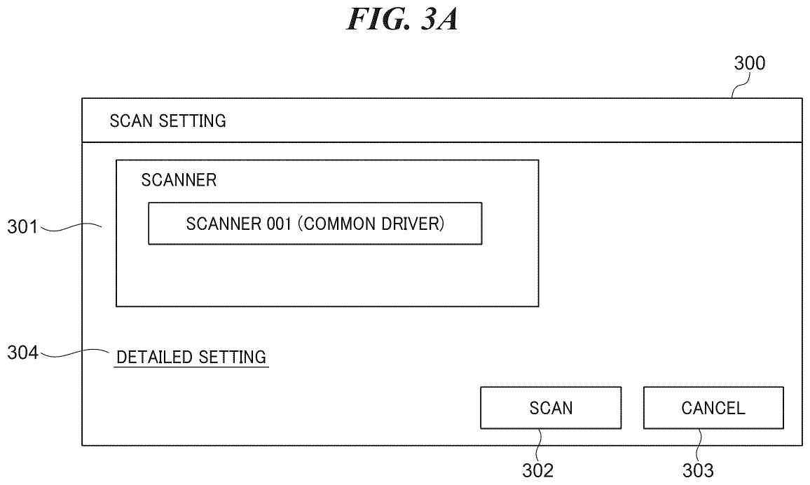

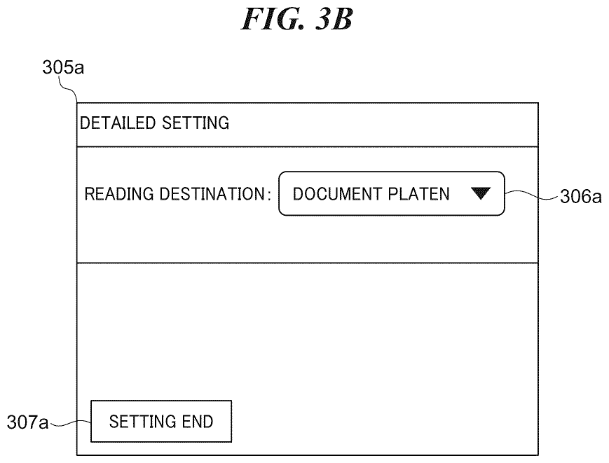

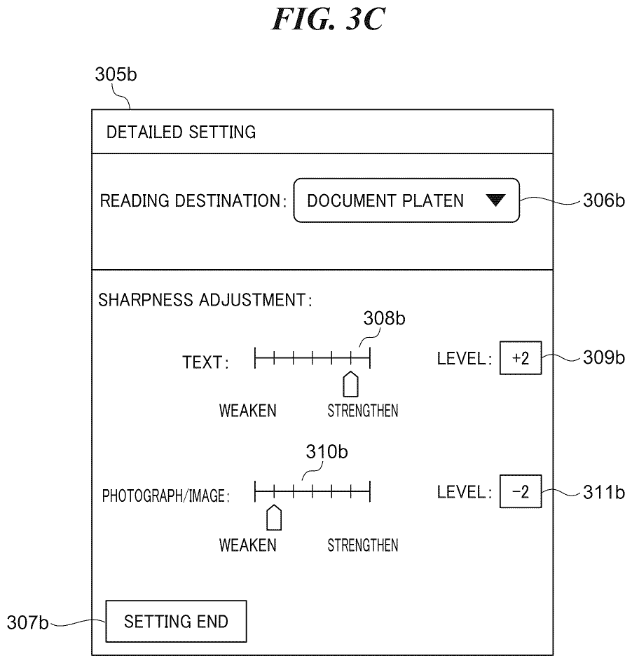

provided by the general purpose scan software 202, the OS of the host computer 101, or the scan application 201 is displayed on the display unit 119 of the host computer 101. In addition, when a detailed setting button on this scan setting screen is pressed, the general purpose scan software 202 causes the display unit 119 of the host computer 101 to display a detailed setting screen. It should be noted that the configurations of the scan setting screen and the detailed setting screen will be described below with reference to FIGS. 3A, 3B, and 3C. The detailed setting screen includes setting items (hereinafter, also referred to as “control items”) indicating scan functions supported by the general purpose scan software 202 and control items indicating setting values thereof, according to capability information of the general purpose scan software 202.

The general purpose scan software 202 is a general purpose program that is capable of being used in common with respect to scan apparatuses from a plurality of manufacturers, and is also a general purpose program that generates and outputs instructions that are capable of being commonly interpreted by the scan apparatuses from the plurality of manufacturers. The general purpose scan software 202 is, for example, a standard class driver that controls the execution of a scan processing based on a standard scan protocol called Mopria. The general purpose scan software 202 decides scanning capabilities based on the scan function information 203.

The scan function information 203 is data indicating scan functions, in which all scan functions supported by the general purpose scan software 202, their setting values, and exclusive relationships between the setting values have been described. The scan function information 203 is included in the configuration file of the general purpose scan software 202 and is stored in the external storage device 114 as an unchangeable file. Alternatively, the scan function information 203 is dynamically generated by the general purpose scan software 202 or the OS of the host computer 101. Specifically, the general purpose scan software 202 or the OS of the host computer 101 obtains attribute data of the scan apparatus 102 from the scan apparatus 102, and generates the scan function information 203 based on the obtained attribute data. It should be noted that the attribute data of the scan apparatus 102 includes attribute information indicating functions that are capable of being designated in the scan apparatus 102 (attribute information indicating capabilities of the scan apparatus) and setting values corresponding to the attribute information. The attribute data of the scan apparatus 102 that has been obtained from the scan apparatus 102 is stored in the RAM 113. It should be noted that in the case where the scan function information 203 is dynamically generated, the generated scan function information 203 is editable.

By dynamically generating the scan function information 203 in this way, the general purpose scan software 202 is able to allow the user to designate scan functions that are supported by the general purpose scan software 202 and that are capable of being used in the scan apparatus 102 connected to the host computer 101. In other words, regardless of whether a scan apparatus with different functions or a scan apparatus developed by any manufacturer is connected to the host computer 101, the user is able to designate scan functions that are supported by the general purpose scan software 202 and that are capable of being used in the scan apparatus connected to the host computer 101. However, since the general purpose scan software 202 does not support manufacturer-specific functions, it is not possible to allow the user to designate a manufacturer-specific scan function that is a scan function capable of being used in the scan apparatus connected to the host computer 101. An example of the manufacturer-specific scan function is a sharpness adjustment function.

The sharpness adjustment function is a function for adjusting the sharpness of an image that has been read (a scanned image). By scanning a document (an original) using the sharpness adjustment function, the user is able to obtain image data in which the outlines of characters and lines are clear, or image data in which the outlines of halftone dots in a halftone document (a halftone original) are blurred to reduce moire.

In the first embodiment, as setting values of the sharpness adjustment function, the user is able to set an adjustment level that indicates the sharpness of a text area in the scanned image (the image that has been read), and an adjustment level that indicates the sharpness of a photograph area/an image area in the scanned image, respectively. In the following, as an example, a configuration in which the adjustment levels are capable of being set within a range of −3 to +3 for the text area and the photograph area/the image area will be described. It should be noted that the range of the adjustment levels, within which the adjustment levels are capable of being set, is not limited to the range of −3 to +3, and the adjustment levels may be capable of being set within a range wider than the range of −3 to +3, or may be capable of being set within a range narrower than the range of −3 to +3. In the first embodiment, −3 is a setting that weakens the sharpness the most (that is, a setting that strongly blurs the outlines), 0 is the default setting, and +3 is a setting that strengthens the sharpness the most (that is, a setting that strongly emphasizes the outlines).

It should be noted that the same adjustment level may be set for the text area and the photograph area/the image area without distinction. In addition, the adjustment level may be capable of being set only for the text area, or the adjustment level may be capable of being set only for the photograph area/the image area. In addition, a configuration may be adopted in which, in addition to the text area and the photograph area/the image area, it is possible to add an area with an attribute for which an adjustment level is capable of being set. In addition, a configuration may be adopted in which, a plurality of areas in the image data are designated, and an adjustment level is capable of being set for each of the plurality of areas that have been designated.

Next, a software configuration for the host computer 101 that includes the extended application 204 to instruct the scan apparatus 102 to execute a scan processing will be described.

FIG. 2B shows the software configuration for the host computer 101 that includes the extended application 204 to instruct the scan apparatus 102 to execute a scan processing. It should be noted that in FIG. 2B, configurations and processes that are not specifically described are the same as those in FIG. 2A.

As shown in FIG. 2B, as the software for instructing the scan apparatus 102 to execute a scan processing, the host computer 101 includes the extended application 204 in addition to the scan application 201 and the general purpose scan software 202 that have been described above. The processes performed by these software are realized by the CPU 111 executing programs that have been stored in the external storage device 114.

The extended application 204 is software that supports the general purpose scan software 202, and is software that is not included in advance in the OS of the host computer 101 (that is not bundled with the OS of the host computer 101). Therefore, the user needs to operate the host computer 101 to download the extended application 204 from a server via the Internet and install the extended application 204 into the host computer 101. Alternatively, the extended application 204 may be automatically installed into the host computer 101 based on the connection of the scan apparatus 102 to the host computer 101. Specifically, in the case where the scan apparatus 102 is connected to the host computer 101, the OS of the host computer 101 obtains device identification information from the scan apparatus 102. The OS of the host computer 101 may download the extended application 204 corresponding to the obtained device identification information from the server via the Internet and then install the extended application 204. In other words, the general purpose scan software 202 and the extended application 204 are retained in the host computer 101 as separate files.

It should be noted that the general purpose scan software 202 and the extended application 204 may be updated and upgraded, but an update processing of the general purpose scan software 202 and an update processing of the extended application 204 are performed at different timings. In other words, the timing at which the host computer 101 obtains the general purpose scan software 202 differs from the timing at which the host computer 101 obtains the extended application 204. In addition, a trigger for the host computer 101 to obtain the general purpose scan software 202 differs from a trigger for the host computer 101 to obtain the extended application 204. It should be noted that in the case where the extended application 204 has been installed into the host computer 101, the OS of the host computer 101 associates the extended application 204 with the general purpose scan software 202 and the scan apparatus 102.

The extended application 204 includes a scan setting screen extending unit 205, a scan function extending unit 206, an image data editing unit 207, and a notifying unit 209. In addition, the extended application 204 includes shared information 208 that is capable of being commonly accessed from each unit of the scan setting screen extending unit 205, the scan function extending unit 206, the image data editing unit 207, and the notifying unit 209. The shared information 208 is actually a file that has been stored in the external storage device 114 or information that has been stored in the RAM 113. The extended application 204 uses an application program interface (an API) provided by the OS of the host computer 101 to write and read information to and from the shared information 208.

It should be noted that the extended application 204 may terminate its operation each time the processing of each unit of the scan setting screen extending unit 205, the scan function extending unit 206, the image data editing unit 207, and the notifying unit 209 is completed. In this case, the OS of the host computer 101 will activate the extended application 204 every time the OS of the host computer 101 receives a request to use each unit of the scan setting screen extending unit 205, the scan function extending unit 206, the image data editing unit 207, and the notifying unit 209.

Furthermore, the extended application 204 may cancel the processing of each unit of the scan setting screen extending unit 205, the scan function extending unit 206, the image data editing unit 207, and the notifying unit 209 during the processing of each unit of the scan setting screen extending unit 205, the scan function extending unit 206, the image data editing unit 207, and the notifying unit 209. In the case where the processing of each unit has been canceled, a job being processed is deleted by the OS of the host computer 101.

When the scan application 201 receives a scan request from the user, the scan application 201 issues a scan instruction to the OS of the host computer 101. In the configuration shown in FIG. 2B, similar to the configuration shown in FIG. 2A, the scan application 201 is able to cause to display a scan setting screen. In the configuration shown in FIG. 2B, a detailed setting screen provided by the extended application 204 is displayed. Specifically, a detailed setting screen provided by the scan setting screen extending unit 205 of the extended application 204 is displayed. In addition, the scan setting screen extending unit 205 stores, in the shared information 208, setting values that have been set by the user on the detailed setting screen.

The image data editing unit 207 performs editing of the image data that has been obtained from the scan apparatus 102. The image data editing unit 207 obtains, from the shared information 208, the setting values that have been set on the detailed setting screen, and performs image editing in accordance with the setting values with respect to the image data. It should be noted that the extended application 204 may obtain image data, which has been obtained by the general purpose scan software 202, and perform image editing in accordance with the setting values with respect to the image data, which has been obtained by the general purpose scan software 202. In addition, in the configuration shown in FIG. 2B, there is a case where the setting of the sharpness adjustment function is not performed by the user. In such a case, as in the configuration shown in FIG. 2A, the general purpose scan software 202 may issue a scan instruction to the scan apparatus 102 without going through the extended application 204.

The scan function extending unit 206 is able to edit the scan function information 203 that has been generated by the general purpose scan software 202 or the OS of the host computer. As a result, the scan function extending unit 206 is able to add, to the scan function information 203, functions provided by the extended application 204. In addition, the scan function extending unit 206 is able to perform the addition of a scan function that is supported by the scan apparatus 102, but is not supported by the general purpose scan software 202, the addition of the exclusive relationship between setting values of this scan function, and the like. It should be noted that the scan function that is supported by the scan apparatus 102, but is not supported by the general purpose scan software 202 is, for example, the sharpness adjustment function. The OS of the host computer 101 activates the scan function extending unit 206 when the extended application 204 has been first associated with the scan apparatus 102 and the general purpose scan software 202. Furthermore, the OS of the host computer 101 may activate the scan function extending unit 206 at a timing other than the above timing, such as the timing of the start-up of the OS of the host computer 101.

The notifying unit 209 is able to display a notification to the user, in response to the occurrence of an error in the scan apparatus 102. For example, when a reading jam error occurs in the scan apparatus 102, the general purpose scan software 202 detects the occurrence of the reading jam error. By using a notifying function called a toast notification, which is one of the functions of the OS of the host computer 101, the OS of the host computer 101 causes the display unit 119 to display a message. When the user presses the toast notification, the notifying unit 209 of the extended application 204 is called out by the OS of the host computer 101, and a user interface screen (a UI screen) of the notifying unit 209 is displayed. On the UI screen of the notifying unit 209, for example, detailed information about the reading jam error, a method for clearing the jam, etc. are displayed.

It should be noted that the configuration of the extended application 204 is not limited to including all of the functions (the units) that have been described, but may include only some of the functions (the units) that have been described, or may include other functions. In addition, the extended application 204 is sometimes simply referred to as “scan software”. As described above, the extended application 204 can be said to include at least one of the following functions. The first function is a function to display a setting screen (the scan setting screen extending unit 205). The second function is a function to edit the image data in accordance with the detailed setting (the image data editing unit 207). The third function is a function to extend the functions that are capable of being designated by the user (the scan function extending unit 206). The fourth function is a function to display a screen in response to the occurrence of an error in the scan apparatus 102 (the notifying unit 209).

Next, examples of the scan setting screen and the detailed setting screen that are displayed on the display unit 119 of the host computer 101 will be described with reference to FIGS. 3A, 3B, and 3C.

FIG. 3A is an example of a scan setting screen 300 displayed by the scan application 201 of FIG. 2A. As shown in FIG. 3A, the scan setting screen 300 includes a control 301, a scan button 302, a cancel button 303, and a detailed setting button 304.

The control 301 includes an object for allowing the user to designate a scanner apparatus to be used for scanning (reading) a document. The scan button 302 is a button for instructing to start scanning. The cancel button 303 is a button for instructing to stop scanning. The detailed setting button 304 is a button for issuing an instruction that causes the display unit 119 to display a detailed setting screen. It should be noted that in the first embodiment, the configuration of the detailed setting screen displayed on the display unit 119 differs depending on whether the host computer 101 includes the extended application 204 or not.

For example, a detailed setting screen 305a of FIG. 3B is displayed on the display unit 119 of the host computer 101 (for example, see FIG. 2A) that does not include the extended application 204. When the user has pressed the detailed setting button 304, the detailed setting screen 305a is displayed on the display unit 119 by the general purpose scan software 202. The detailed setting screen 305a includes a control 306a and a setting end button 307a. By using the control 306a, it is possible to set a reading destination, and in FIG. 3B, as an example, “document platen” has been set. The setting end button 307a is a button for ending the setting on the detailed setting screen 305a. When the user presses the setting end button 307a, the screen of the display unit 119 returns to the scan setting screen 300.

On the other hand, a detailed setting screen 305b of FIG. 3C is displayed on the display unit 119 of the host computer 101 (for example, see FIG. 2B) that includes the extended application 204. When the user has pressed the detailed setting button 304, the detailed setting screen 305b is displayed on the display unit 119 by the scan setting screen extending unit 205. It should be noted that in the first embodiment, a configuration in which the scan setting screen extending unit 205 causes the display unit 119 to display the detailed setting screen 305b will be described, but the present invention is not limited to this configuration. For example, the scan setting screen extending unit 205 may be configured to only generate display data for the detailed setting screen 305b. In this case, the scan setting screen extending unit 205 transmits the generated display data to the scan application 201 via the general purpose scan software 202. The scan application 201 causes the display unit 119 to display the detailed setting screen 305b by using the obtained display data.

The detailed setting screen 305b includes a control 306b having the same function as the above-described control 306a, a setting end button 307b having the same function as the above-described setting end button 307a, and controls 308b to 311b.

The control 308b is a slide bar for selecting the adjustment level that indicates the sharpness of the text area in the scanned image. The user is able to move this slide bar left or right to strengthen (increase) or weaken (decrease) the sharpness of the text area. The currently selected adjustment level is also capable of being confirmed from the control 309b. In addition, by directly inputting a numerical value into the control 309b, it is also possible to set the adjustment level for the text area. It should be noted that in FIG. 3C, as an example, “+2” has been selected as the adjustment level for the text area. The control 308b and the control 309b are linked, so that when the user changes a setting value by using either of them, the display of the other setting value is similarly changed.

The control 310b is a slide bar for selecting the adjustment level that indicates the sharpness of the photograph area/the image area in the scanned image. The user is able to move this slide bar left or right to strengthen (increase) or weaken (decrease) the sharpness of the photograph area/the image area. The currently selected adjustment level is also capable of being confirmed from the control 311b. In addition, by directly inputting a numerical value into the control 311b, it is also possible to set the adjustment level for the photograph area/the image area. It should be noted that in FIG. 3C, as an example, “−2” has been selected as the adjustment level for the photograph area/the image area. It should be noted that in the first embodiment, the setting of the adjustment level is accepted by two means, either a slide bar or by directly inputting a numerical value, but the setting of the adjustment level may be accepted by only one of the two means, or may be accepted by a different setting means, such as by inputting a numerical value with a button to select a numerical value.

Here, the reason why the setting items differ between the detailed setting screen 305a and the detailed setting screen 305b will be described.

The detailed setting screen 305a displayed on the display unit 119 of the host computer 101 that does not include the extended application 204 is generated by referring to the scanning capabilities that have been generated based on the scan function information 203. As described above, the scan function information 203 includes the information about the scan functions supported by the general purpose scan software 202. However, since the general purpose scan software 202 does not support the sharpness adjustment function, the scan function information 203 does not include information about the sharpness adjustment function. As a result, the detailed setting screen 305a does not include the controls 308b to 311b for performing the setting related to the sharpness adjustment function.

On the other hand, the detailed setting screen 305b displayed on the display unit 119 of the host computer 101 that includes the extended application 204 is generated by referring to the scanning capabilities that have been generated based on the scan function information 203 edited by the scan function extending unit 206. To this scan function information 203, the information about the sharpness adjustment function has been added by the scan function extending unit 206. As a result, the detailed setting screen 305b includes the controls 308b to 311b for performing the setting related to the sharpness adjustment function. It should be noted that the detailed setting screen 305b may further include setting item(s) for manufacturer-specific scan function(s) other than the sharpness adjustment function.

Next, an edit control processing in which the scan function extending unit 206 edits the scan function information 203 will be described.

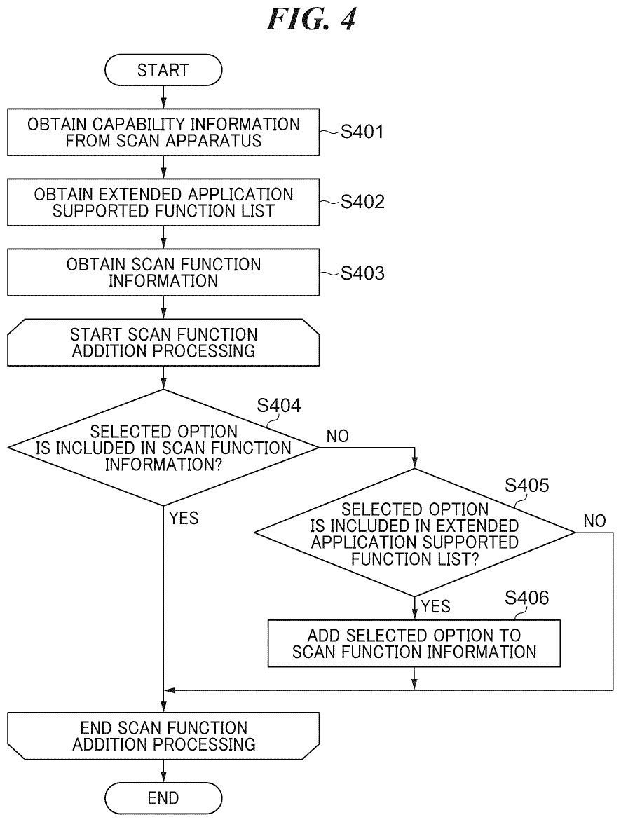

FIG. 4 is a flowchart that shows the procedure of the edit control processing executed by the scan function extending unit 206 shown in FIG. 2B. The edit control processing shown in FIG. 4 is realized by the CPU 111 executing the program of the extended application 204 that has been loaded from the external storage device 114 into the RAM 113. The edit control processing shown in FIG. 4 is executed, for example, when the extended application 204 is started, when the scan apparatus 102 is selected by the control 301 on the scan setting screen 300, or the like.

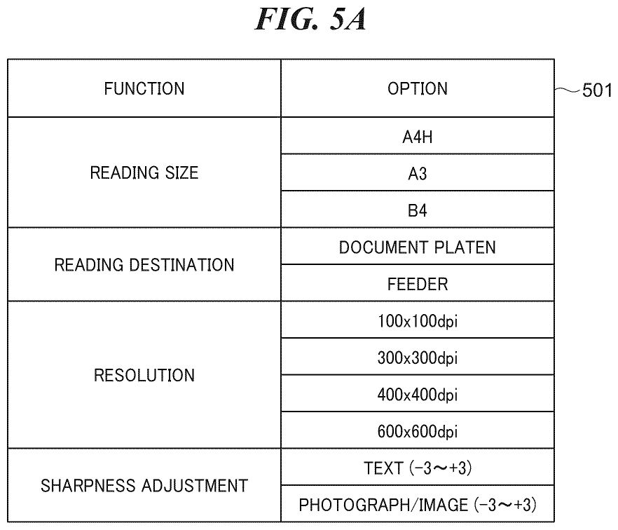

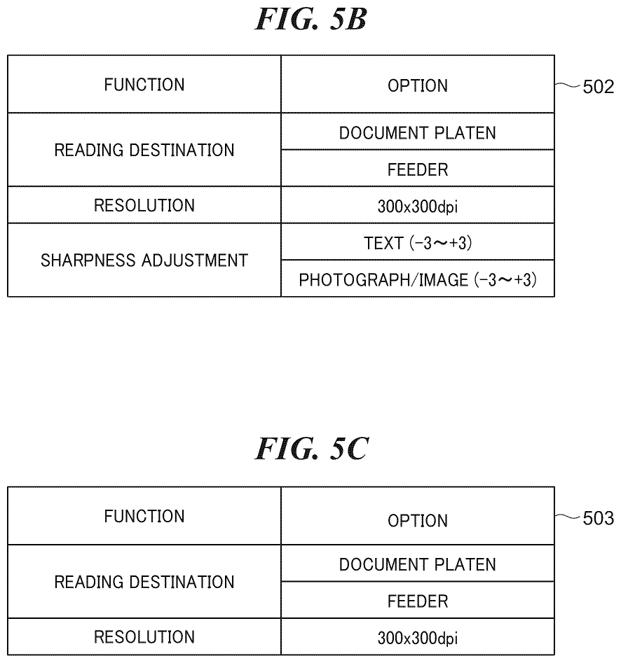

As shown in FIG. 4, first, in S401, the scan function extending unit 206 obtains capability information from the scan apparatus 102 that is connected to the host computer 101. This capability information includes the attribute information indicating the functions that are capable of being designated in the scan apparatus 102, and the setting values related to the attribute information. A table 501 shown in FIG. 5A is an example of the capability information that has been obtained from the scan apparatus 102. As shown in the table 501, it is possible from the scan apparatus 102 to obtain information about functions such as a reading size and the sharpness adjustment, and information about options that are setting values that are capable of being set for each of the functions. Next, in S402, the scan function extending unit 206 obtains a list of scan functions supported by the extended application 204 (hereinafter, referred to as “an extended application supported function list”). The extended application supported function list is capability information of the extended application 204 and has been registered in the shared information 208. The extended application supported function list includes all the scan functions supported by the extended application 204 and their setting values. A table 502 shown in FIG. 5B is an example of the extended application supported function list. The extended application supported function list may be updated by, for example, updating the extended application 204.

Next, in S403, the scan function extending unit 206 obtains the scan function information 203, which has been created by the general purpose scan software 202, from the OS. A table 503 shown in FIG. 5C is an example of the scan function information 203 that has been created by the general purpose scan software 202. The general purpose scan software 202 creates the scan function information 203 based on the capability information that has been obtained from the scan apparatus 102 (for example, see the table 501 shown in FIG. 5A). The scan function information 203 created by the general purpose scan software 202 records (includes) only scan functions that are supported by the general purpose scan software 202 from among a plurality of scan functions recorded (included) in the capability information obtained from the scan apparatus 102. For this reason, the functions recorded (included) in the scan function information 203 are limited. For example, the capability information shown in FIG. 5A includes the information about the sharpness adjustment function, but the general purpose scan software 202 does not support the sharpness adjustment function (for example, see the table 503 shown in FIG. 5C). Therefore, the scan function information 203 does not record (does not include) the information about the sharpness adjustment function. In the first embodiment, the scan function extending unit 206 adds functions and options thereof to such scan function information 203, which enables the extended application 204 to compensate for insufficient functions of the general purpose scan software 202. In addition, the scan function extending unit 206 is also able to delete unnecessary functions and options thereof from the scan function information 203 created by the general purpose scan software 202.

Next, the scan function extending unit 206 performs a scan function addition processing. Specifically, the scan function extending unit 206 performs S404, S405, and S406. The scan function addition processing is a processing that is repeatedly performed for each option of the functions recorded (included) in the capability information that has been obtained from the scan apparatus 102 in S401. In the first embodiment, the scan function addition processing is repeatedly performed for eleven items in the capability information shown in FIG. 5A, from “A4H” that is an option of the reading size to “photograph/image (−3 to +3)” that is an option of the sharpness adjustment function. The scan function extending unit 206 selects one option from among the options in the capability information that has been obtained in S401.

First, in S404, the scan function extending unit 206 determines whether or not the selected option is included in the scan function information 203 that has been generated by the general purpose scan software 202. For example, in the case where “document platen” that is an option of the reading destination has been selected from the capability information shown in FIG. 5A, this “document platen” is included in the scan function information 203 shown in FIG. 5C. In such a case, it is determined in S404 that the selected option is included in the scan function information 203 that has been generated by the general purpose scan software 202. On the other hand, in the case where “A4H” that is the option of the reading size has been selected from the capability information shown in FIG. 5A, this “A4H” is not included in the scan function information 203 shown in FIG. 5C. In such a case, it is determined in S404 that the selected option is not included in the scan function information 203 that has been generated by the general purpose scan software 202.

In the case of having been determined in S404 that the selected option is included in the scan function information 203 that has been generated by the general purpose scan software 202, the scan function extending unit 206 selects the next option, and the edit control processing returns to S404. It should be noted that in the case where the option, for which the determination in S404 has been performed, is the last option in the capability information that has been obtained in S401 (for example, “photograph/image (−3 to +3)” shown in FIG. 5A), the scan function addition processing ends, and the edit control processing ends.

In the case of having been determined in S404 that the selected option is not included in the scan function information 203 that has been generated by the general purpose scan software 202, the edit control processing proceeds to S405.

In S405, the scan function extending unit 206 determines whether or not the selected option is included in the extended application supported function list that has been obtained in S402. For example, in the case where “100×100 dpi” that is an option of a resolution has been selected from the capability information shown in FIG. 5A, this “100×100 dpi” is not included in the extended application supported function list shown in FIG. 5B. In such a case, in S405, it is determined that the selected option is not included in the extended application supported function list, the scan function extending unit 206 selects the next option, and the edit control processing returns to S404. It should be noted that in the case where the option, for which the determination in S405 has been performed, is the last option in the capability information that has been obtained in S401, the scan function addition processing ends, and the edit control processing ends.

On the other hand, in the case where “text (−3 to +3)” that is an option of the sharpness adjustment function has been selected from the capability information shown in FIG. 5A, this “text (−3 to +3)” is included in the extended application supported function list shown in FIG. 5B. In such a case, in S405, it is determined that the selected option is included in the extended application supported function list, and the edit control processing proceeds to S406.

In S406, the scan function extending unit 206 adds the selected option to the scan function information 203. Next, the scan function extending unit 206 selects the next option, and the edit control processing returns to S404. It should be noted that in the case where the option, which has been added to the scan function information 203 in S406, is the last option in the capability information that has been obtained in S401, the scan function addition processing ends, and the edit control processing ends.

In this way, the scan function extending unit 206 adds, to the scan function information 203, the options of the scan function that is not supported by the general purpose scan software 202 but is supported by the scan apparatus 102 and the extended application 204. The scanning capabilities are generated based on the scan function information 203 that has been edited by the edit control processing of FIG. 4 that has been described above. Furthermore, the scan setting screen extending unit 205 generates the display data for the detailed setting screen based on the generated scanning capabilities. As a result, it becomes possible to display the detailed setting screen 305b shown in FIG. 3C on which the scan function that is not supported by the general purpose scan software 202 but is supported by the scan apparatus 102 and the extended application 204 is capable of being set.

Next, a scan control processing in the communication system shown in FIG. 1 from when a scan setting is accepted to when image data generated by scanning a document (an original) by the scan apparatus 102 is displayed will be described.

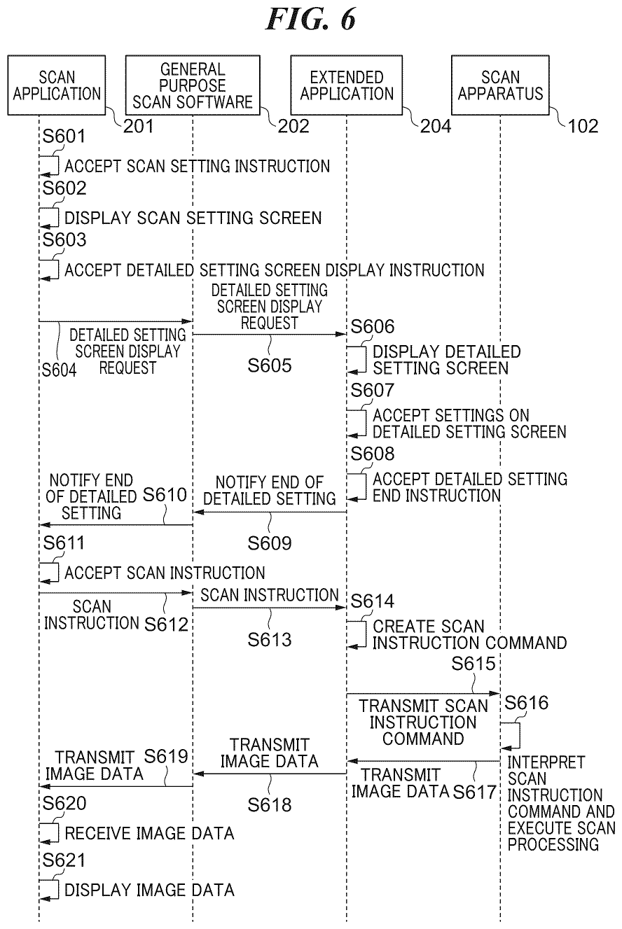

FIG. 6 is a sequence diagram that shows the procedure of the scan control processing executed in the communication system shown in FIG. 1. The processes performed by the host computer 101 in FIG. 6 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 6 are realized by the CPU 191 of the scan apparatus 102 loading the program, which has been stored in the ROM 192 or the external storage device 199, into the RAM 193 and executing it. It should be noted that in the first embodiment, as shown in FIG. 2B described above, the scan control processing in the configuration, in which the host computer 101 includes the extended application 204, will be described. In addition, in the scan control processing shown in FIG. 6, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 6, first, in S601, the scan application 201 accepts a scan setting instruction from the user. The scan setting instruction is an instruction for performing a scan setting to be used in a scan processing to be executed by the scan apparatus 102 connected to the host computer 101. The user is able to operate the pointing device 117 and/or the keyboard 118 to issue the scan setting instruction to the scan application 201.

Next, in S602, the scan application 201 causes the display unit 119 to display the scan setting screen 300 in accordance with the accepted scan setting instruction.

Next, in S603, the scan application 201 accepts a detailed setting screen display instruction (an instruction to display a detailed setting screen). The user is able to operate the pointing device 117 and/or the keyboard 118 to select the detailed setting button 304 on the scan setting screen 300 to issue the detailed setting screen display instruction.

Next, in S604, the scan application 201 makes a detailed setting screen display request with respect to the general purpose scan software 202 in accordance with the accepted detailed setting screen display instruction.

Next, in S605, the general purpose scan software 202 makes the detailed setting screen display request with respect to the extended application 204 in accordance with the accepted display request. It should be noted that, as shown in

FIG. 2A described above, with the configuration in which the host computer 101 does not include the extended application 204, the general purpose scan software 202 will cause the display unit 119 to display the detailed setting screen 305a.

Next, in S606, the scan setting screen extending unit 205 of the extended application 204 causes the display unit 119 to display the detailed setting screen 305b. Specifically, the scan setting screen extending unit 205 refers to the scanning capabilities generated based on the scan function information 203 to which the options of the sharpness adjustment function or the like have been added through the edit control processing of FIG. 4 described above, and causes the display unit 119 to display the detailed setting screen 305b. As described above, the detailed setting screen 305b includes the controls 308b to 311b for setting the setting values of the sharpness adjustment function. It should be noted that in the first embodiment, the resolution supported by the extended application 204, as shown in FIG. 5B, only has one option, that is, 300×300 dpi, so there is no need for the user to select the option of the resolution, and a setting item for the resolution is not included in the detailed setting screen 305b. It should be noted that this configuration is merely an example, and the detailed setting screen 305b may include the setting item for the resolution in which 300×300 dpi has been selected.

Next, in S607, the scan setting screen extending unit 205 accepts settings on the detailed setting screen 305b by the user. The detailed setting screen 305b of FIG. 3C shows an example in which the user has set “document platen” as the reading destination, has set “+2” as the adjustment level for the text area, and has set “−2” as the adjustment level for the photograph area/the image area. The values that have been set on the detailed setting screen 305b are stored in the RAM 113 by the CPU 111.

Next, in S608, the scan setting screen extending unit 205 accepts an instruction to end the detailed setting (a detailed setting end instruction) from the user. The user is able to operate the pointing device 117 and/or the keyboard 118 to select the setting end button 307b to issue the detailed setting end instruction. The scan setting screen extending unit 205, which has received the detailed setting end instruction, writes the setting values that have been set on the detailed setting screen 305b into the scan setting information. It should be noted that the scan setting screen extending unit 205 may be configured to also write the setting value of the item that has not been selected by the user, such as the resolution, into the scan setting information. The scan setting information is retained in the RAM 113 or the like.

Next, in S609, the extended application 204 notifies the general purpose scan software 202 of the end of the detailed setting.

Next, in S610, the general purpose scan software 202 notifies the scan application 201 of the end of the detailed setting.

Upon receiving this notification, the scan application 201 switches the screen of the display unit 119 to the scan setting screen 300. In addition, in S611, the scan application 201 accepts a scan instruction from the user. The user is able to operate the pointing device 117 and/or the keyboard 118 to select the scan button 302 to issue the scan instruction.

Next, in S612, the scan application 201 issues the scan instruction to the general purpose scan software 202.

Next, in S613, the general purpose scan software 202 issues the scan instruction to the extended application 204.

Next, in S614, the extended application 204 creates a scan instruction command based on the scan setting information written in S608. In the case where the setting value of the item that has not been selected by the user such as the resolution has not been written into the scan setting information in S608, the extended application 204 may be configured to add the setting value of the item that has not been selected by the user such as the resolution to the scan instruction command when creating the scan instruction command in S614. In addition, a configuration may be adopted in which the setting value of the item that has not been selected by the user such as the resolution is caused to operate as the default value of the scan apparatus 102 without adding the setting value of the item that has not been selected by the user such as the resolution to the scan instruction command.

Next, in S615, the extended application 204 transmits (outputs) the scan instruction command to the scan apparatus 102.

Next, in S616, the scan apparatus 102 interprets the received scan instruction command and executes a scan processing. In S616, image processing corresponding to the scan instruction command is performed on the image data obtained by scanning the document. It should be noted that in the first embodiment, in the case where the setting values of the sharpness adjustment function have been set on the detailed setting screen 305b, sharpness adjustment corresponding to the setting values that have been set is performed. As a result, image data, with respect to which the sharpness adjustment corresponding to the setting values that have been set has been performed for the text area and the photograph area/the image area, is generated.

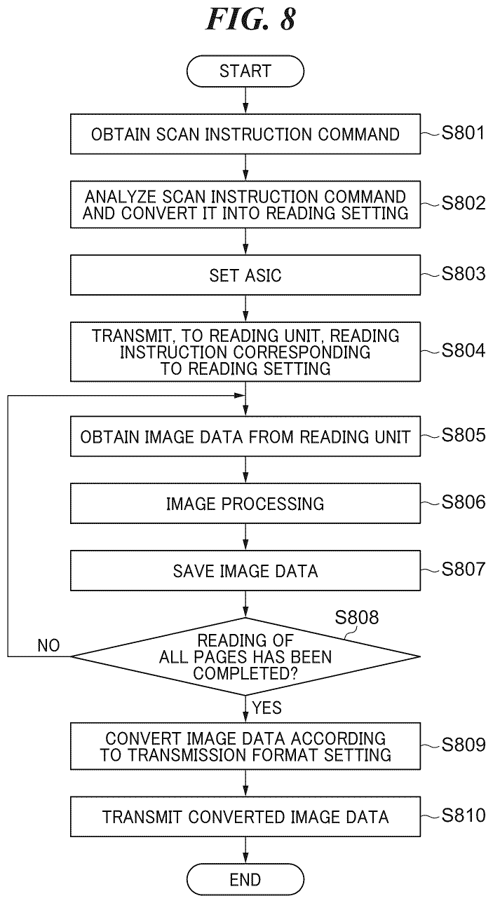

Next, in S617, the scan apparatus 102 transmits the generated image data to the extended application 204. It should be noted that the above-described processes of S616 and S617 executed by the scan apparatus 102 will be described below with reference to FIG. 8.

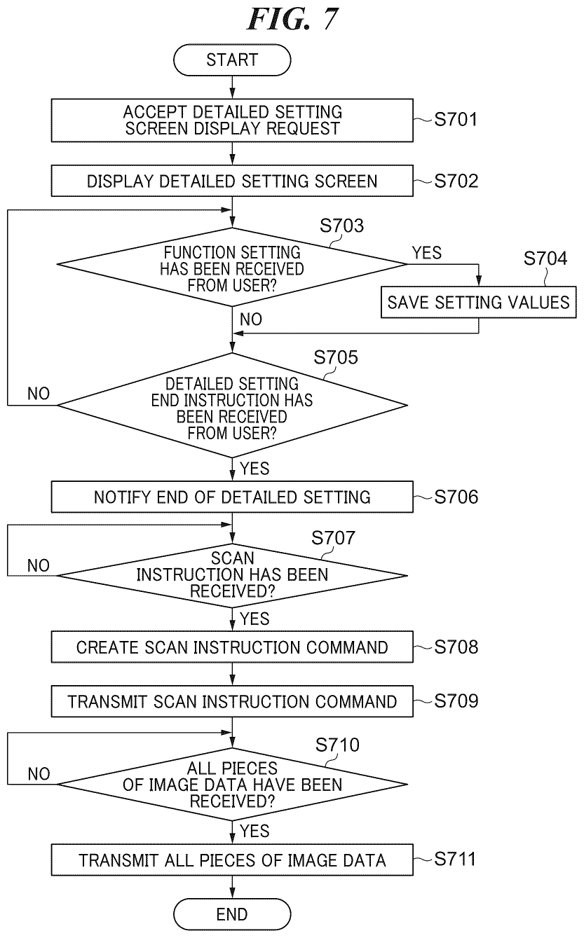

Next, in S618, the extended application 204 transmits the received image data to the general purpose scan software 202. It should be noted that the above-described processes of S606, S607, S608, S609, S614, S615, and S618 executed by the extended application 204 will be described below with reference to FIG. 7.

Next, in S619, the general purpose scan software 202 transmits the received image data to the scan application 201.

Next, in S620, the scan application 201 receives the image data. Next, in step S621, the scan application 201 displays the received image data on the display unit 119. The display unit 119 displays, for example, image data that has been generated by the scan processing performed by the scan apparatus 102, and with respect to which the sharpness adjustment has been performed with the setting value that has been set by the control 308b. When the process of S621 is completed, the scan control processing shown in FIG. 6 ends.

Next, a scan instruction command generation processing executed by the extended application 204 will be described. The scan instruction command generation processing includes the above-described processes of S606, S607, S608, S609, S614, S615, and S618.

FIG. 7 is a flowchart that shows the procedure of the scan instruction command generation processing executed by the extended application 204 shown in FIG. 2B. The scan instruction command generation processing shown in FIG. 7 is realized by the CPU 111 executing the program of the extended application 204 that has been loaded from the external storage device 114 into the RAM 113.

As shown in FIG. 7, first, in S701, the extended application 204 accepts the detailed setting screen display request from the general purpose scan software 202. Next, in S702, the scan setting screen extending unit 205 of the extended application 204 causes the display unit 119 to display the detailed setting screen 305b in accordance with the accepted display request (for example, see S606 described above).

Next, in S703, the scan setting screen extending unit 205 determines whether or not a function setting on the detailed setting screen 305b has been received from the user.

In the case of having been determined in S703 that a function setting on the detailed setting screen 305b has been received from the user (for example, see S607 described above), the extended application 204 saves, in the RAM 113, the setting values that have been set on the detailed setting screen 305b (S704).

Thereafter, the scan instruction command generation processing shown in FIG. 7 proceeds to S705.

Also in the case of having been determined in S703 that a function setting on the detailed setting screen 305b has not been received from the user, the scan instruction command generation processing shown in FIG. 7 proceeds to S705.

In S705, the scan setting screen extending unit 205 determines whether or not a detailed setting end instruction has been received from the user.

In the case of having been determined in S705 that a detailed setting end instruction has not been received from the user, the scan instruction command generation processing shown in FIG. 7 returns to S703. In the case of having been determined in S705 that a detailed setting end instruction has been received from the user (for example, see S608 described above), the scan instruction command generation processing shown in FIG. 7 proceeds to S706. It should be noted that in the case where the determination is YES in both S703 and S705, the scan setting screen extending unit 205 writes the setting values that have been set on the detailed setting screen 305b into the scan setting information. Thereafter, the scan instruction command generation processing shown in FIG. 7 proceeds to S706.

In S706, the extended application 204 notifies the general purpose scan software 202 of the end of the detailed setting (for example, see S609 described above).

Next, in S707, the extended application 204 determines whether or not a scan instruction has been received from the general purpose scan software 202. The extended application 204 waits until a scan instruction is received, and when the scan instruction is received (YES in S707), in S708, creates a scan instruction command based on the scan setting information written in S705 (for example, see S614 described above). As a method for creating a scan instruction command, there is a method for extending a function to a command conforming to a standard protocol. Examples of the method for extending a function to a command conforming to a standard protocol include a method to record the setting values of the sharpness adjustment function or the like as a dedicated command in an extension area of the command conforming to the standard protocol, and a method to add a manufacturer-specific command to the end of the command conforming to the standard protocol. In addition, as the method for creating a scan instruction command, for example, there is a method in which the extended application 204 converts a command conforming to a standard protocol into a unique command system. In addition, in the case of issuing an instruction from the extended application 204, the instruction and communication may be performed according to a manufacturer's unique protocol, regardless of the standard protocol.

Next, in S709, the extended application 204 transmits (outputs) the scan instruction command to the scan apparatus 102 (for example, see S615 described above).

Next, in S710, the extended application 204 determines whether or not all pieces of the image data have been received from the scan apparatus 102. The extended application 204 waits until all pieces of the image data have been received, and when all pieces of the image data have been received (YES in S710), in S711, the extended application 204 transmits the received image data (all pieces of the image data that have been received) to the general purpose scan software 202 (for example, see S618 described above). Thereafter, the scan instruction command generation processing shown in FIG. 7 ends.

Next, a control processing executed by the scan apparatus 102 will be described. The control processing includes the above-described processes of S616 and S617.

FIG. 8 is a flowchart that shows the procedure of the control processing executed by the scan apparatus 102 shown in FIG. 1. It should be noted that the control processing shown in FIG. 8 is realized by the CPU 191 executing the program that has been stored in the RAM 192.

As shown in FIG. 8, first, in S801, the CPU 191 obtains the scan instruction command that has been transmitted from the extended application 204.

Next, in S802, the CPU 191 analyzes the scan instruction command that has been obtained in S801, and converts it into a reading setting to be used in the scan processing by the scan apparatus 102. In the first embodiment, as an example, it is assumed that the CPU 191 has converted into a reading setting, in which the reading destination is set to “document platen”, the adjustment level of the text area is set to “+2”, the adjustment level of the photograph area/the image area is set to “−2”, and the resolution is set to “300×300 dpi”. Next, in S803, the CPU 191 sets an application specific integrated circuit (an ASIC) of the image processing unit 190 to be used for executing the scan processing based on the reading setting converted in S802.

Next, in S804, the CPU 191 transmits, to the reading unit 195, a reading instruction corresponding to the reading setting. In the first embodiment, for example, the CPU 191 transmits, to the reading unit 195, a reading instruction specifying the reading destination as “document platen”. Upon receiving this reading instruction, the reading unit 195 carries out a reading operation of the document set on the document platen.

Next, in S805, the CPU 191 obtains the image data from the reading unit 195. Next, in S806, the CPU 191 controls the image processing unit 190 to execute an image processing with respect to the obtained image data. In S806, the obtained image data is subjected to, for example, a process of converting the resolution into “300×300 dpi”, and a sharpness adjustment corresponding to the above adjustment levels. In the sharpness adjustment, the ASIC that has been set in S803 is used to analyze the image data, and adjust the sharpness for the text area, the photograph area, and the image area by using the adjustment levels that have been set on the detailed setting screen 305b, respectively. It should be noted that in the case where the reading unit 195 is capable of performing reading at “300×300 dpi” and the reading unit 195 has obtained the image data at “300×300 dpi”, the image processing for converting the resolution into “300×300 dpi” in S806 may not be executed.

Next, in S807, the CPU 191 saves the image data in the external storage device 199. Next, in S808, the CPU 191 determines whether or not reading of all pages has been completed.

In the case of having been determined in S808 that reading of any page has not been completed, the control processing shown in FIG. 8 returns to S805.

In the case of having been determined in S808 that reading of all pages has been completed, the control processing shown in FIG. 8 proceeds to S809. In S809, the CPU 191 controls the image processing unit 190 to convert the image data that has been saved in S807 into a designated transmission format. In the first embodiment, the transmission format is not included in the scan instruction command that has been obtained in S801, and in S809, the image data is converted into the JPEG format, which is the default setting of the scan apparatus 102, but the transmission format, into which the image data is converted, is not limited to the JPEG format. The transmission format, into which the image data is converted, may be a format other than the JPEG format, so long as it is a format supported by the host computer 101. Next, in S810, the CPU 191 controls the NETIF 197 to transmit, to the extended application 204, the image data that has been converted in S809. Thereafter, the control processing shown in FIG. 8 ends.

According to the embodiment described above, the extended application 204 causes the display unit 119 to display the detailed setting screen 305b that accepts the setting of the sharpness adjustment function. In addition, the extended application 204 outputs the scan instruction command for causing the scan apparatus 102 to execute the scan processing with the setting values (the adjustment levels) that have been set on the detailed setting screen 305b. As a result, it is possible to allow the user to use the sharpness adjustment function.

In addition, in the embodiment described above, on the detailed setting screen 305b, the adjustment levels indicating the sharpness of the image data to be generated by the scan processing are set by the user. As a result, it is possible to reflect the user's intention in the sharpness of the image data to be generated.

In addition, in the embodiment described above, on the detailed setting screen 305b, one setting value from among a plurality of different setting values is set by the user. As a result, the user is able to be allowed to select a preferred sharpness setting value from among a plurality of options (the plurality of different setting values).

In addition, in the embodiment described above, on the detailed setting screen 305b, a setting value is set for each attribute of areas in the image data to be generated in the scan processing. As a result, it is possible to set an intended sharpness setting value for each attribute of the areas in the image data to be generated in the scan processing.

In addition, in the embodiment described above, the scan instruction command is a command created by extending the function to a command conforming to a standard protocol. As a result, it is possible to use the standard protocol to cause the scan apparatus 102 to execute a scan processing that generates image data, with respect to which the sharpness adjustment has been performed with the setting values that have been set on the detailed setting screen 305b.

In addition, in the embodiment described above, the scan instruction command is a command obtained by converting a command conforming to a standard protocol into a command system unique to the extended application 204. As a result, it is possible to reflect a setting for a scan function that is not supported by the standard protocol in the scan instruction command.

In addition, in the embodiment described above, the setting items to be displayed on the detailed setting screen 305b are decided by using the capability information of the scan apparatus 102 that has been designated by the user. As a result, it is possible to include, in the detailed setting screen 305b, setting items for scan functions that are not supported by the general purpose scan software 202 but are supported by the scan apparatus 102.

It should be noted that in the embodiment described above, although the configuration has been described in which the detailed setting screen 305b is displayed on the display unit 119 of the host computer 101 (for example, see FIG. 2B) that includes the extended application 204, the present invention is not limited to this configuration. For example, the general purpose scan software 202 that has received the detailed setting screen display request in S604 may cause the display unit 119 to display the detailed setting screen 305a. After completing the settings on the detailed setting screen 305a, the general purpose scan software 202 makes a display request to display an additional detailed setting screen with respect to the extended application 204. In response to this display request, the extended application 204 causes the display unit 119 to display a detailed setting screen (not shown) that, for example, does not include the control 306b and includes the setting end button 307b and the controls 308b to 311b. Even with such a configuration, it is possible to allow the user to use the sharpness adjustment function.

In addition, in the embodiment described above, although the configuration has been described in which the general purpose scan software 202 issues the scan instruction to the extended application 204 in S613, the present invention is not limited to this configuration. For example, the scan application 201 may directly issue a scan instruction to the extended application 204. In addition, a configuration may be adopted in which, a control for issuing a scan instruction is arranged on the detailed setting screen 305b and the user is able to directly issue an instruction to the extended application 204 by using this control.

In addition, in the embodiment described above, although the configuration has been described in which the extended application 204 transfers the image data that has been received from the scan apparatus 102 to the scan application 201 via the general purpose scan software 202, the present invention is not limited to this configuration. For example, the extended application 204 may be configured to directly transfer the image data that has been received from the scan apparatus 102 to the scan application 201 without going through the general purpose scan software 202. In addition, the image data may be transferred from the scan apparatus 102 to the scan application 201. In addition, a configuration may be adopted in which, the image data that has been obtained from the scan apparatus 102 is stored in the external storage device 114, and only information about a file path that indicates a storage destination is transferred.

In addition, in the embodiment described above, although the configuration has been described in which the transfer starts after it is determined in S710 that all pieces of the image data have been received, the present invention is not limited to this configuration. For example, a configuration may be adopted in which the image data is transferred whenever it is transmitted.

In addition, in the embodiment described above, although the configuration has been described in which the scan apparatus 102 transmits the generated image data to the host computer 101, the present invention is not limited to this configuration. For example, the scan apparatus 102 may transmit the generated image data by fax or email to a designated transmission destination. The transmission destination may be saved in the scan apparatus 102, and the process may be completed in the scan apparatus 102 after a scan instruction is issued. In addition, the transmission destination that has been saved in an address book on a computer, a smartphone, or the like may be obtained. In addition, a destination input screen/field may be displayed to allow the user to set the transmission destination.

Next, programs, a communication system, an information processing apparatus, and a control method for the information processing apparatus according to a second embodiment of the present invention will be described. The second embodiment is basically the same as the first embodiment described above in terms of configuration and operation, but differs from the first embodiment described above in that the scan apparatus 102 does not support the sharpness adjustment function. Therefore, descriptions of overlapping configurations and operations will be omitted, and only different configurations and operations will be described below.

In the first embodiment described above, the configuration has been described in which the extended application 204 creates a scan instruction command including the setting values of the sharpness adjustment function, and the scan apparatus 102 executes the scan processing in accordance with the scan instruction command. However, there is a case where the scan apparatus 102 does not support the sharpness adjustment function in the first place. In such a case, the user is not able to use the sharpness adjustment function.

Therefore, in the second embodiment, the extended application 204 determines whether or not the scan apparatus 102 supports the sharpness adjustment function based on the capability information of the scan apparatus 102. In the case where the scan apparatus 102 supports the sharpness adjustment function, the extended application 204 creates a scan instruction command that includes the setting values that have been set on the detailed setting screen 305b, and transmits this scan instruction command to the scan apparatus 102. On the other hand, in the case where the scan apparatus 102 does not support the sharpness adjustment function, the extended application 204 creates a scan instruction command that does not include the setting values of the sharpness adjustment function, and transmits this scan instruction command to the scan apparatus 102. Thereafter, the extended application 204 obtains image data generated by the scan apparatus 102 in accordance with this scan instruction command, and performs sharpness adjustment corresponding to the setting values that have been set on the detailed setting screen 305b with respect to this image data. As a result, even in the case where the scan apparatus 102 does not support the sharpness adjustment function, it is possible to allow the user to use the sharpness adjustment function.

In the following, the differences from the first embodiment described above will be described.

In the second embodiment, it is assumed that the scan apparatus 102 is a scan apparatus that does not support the sharpness adjustment function. In the case where the capability information obtained from the scan apparatus 102 does not include the information about the sharpness adjustment function, the scan function extending unit 206 of the extended application 204 performs processing different from that of the first embodiment described above. Specifically, in the case where the obtained capability information does not include the information about the sharpness adjustment function and the extended application 204 includes a unit for performing sharpness adjustment, the scan function extending unit 206 adds the information about the sharpness adjustment function to the scan function information 203. The image data editing unit 207 performs sharpness adjustment on the image data obtained from the scan apparatus 102 based on the setting values of the sharpness adjustment function that have been set by the user. The details will be described below.

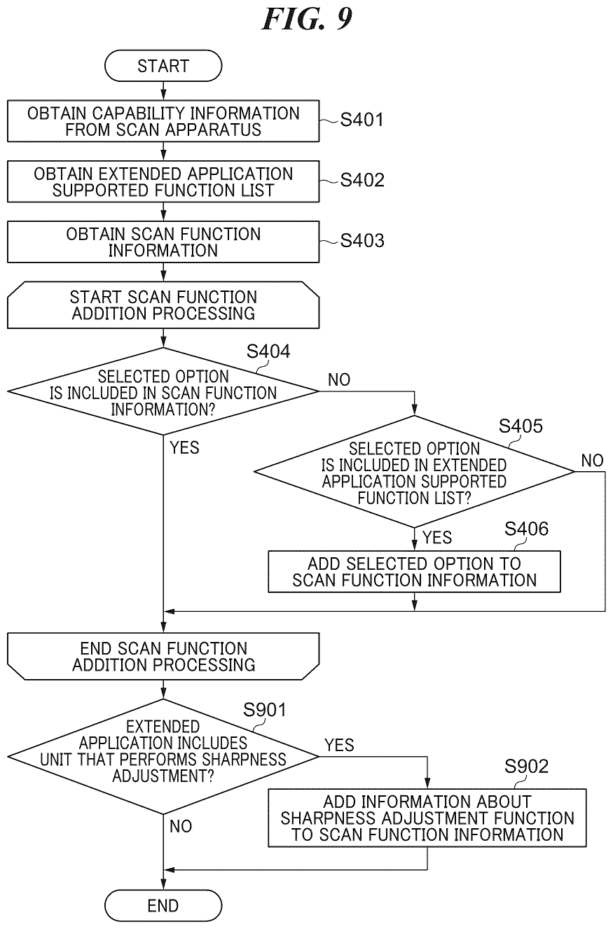

FIG. 9 is a flowchart that shows the procedure of an edit control processing executed by the scan function extending unit 206 according to the second embodiment. It should be noted that the edit control processing shown in FIG. 9 is a processing similar to the edit control processing shown in FIG. 4 described above, and the following will particularly describe the differences from the edit control processing shown in FIG. 4 described above. Similar to the edit control processing shown in FIG. 4 described above, the edit control processing shown in FIG. 9 is also realized by the CPU 111 executing the program of the extended application 204 that has been loaded from the external storage device 114 into the RAM 113. Similar to the edit control processing shown in FIG. 4 described above, the edit control processing shown in FIG. 9 is executed, for example, when the extended application 204 is started.

As shown in FIG. 9, first, S401 to S403 that have been described are performed, and then the scan function addition processing (S403 to S406) is performed. Here, since the scan apparatus 102 does not support the sharpness adjustment function, in the scan function addition processing (S403 to S406), the information about the sharpness adjustment function is not added to the scan function information 203.

Next, in S901, the scan function extending unit 206 determines whether or not the extended application 204 includes a unit that performs sharpness adjustment. The unit that performs sharpness adjustment is, for example, the image data editing unit 207.

In the case of having been determined in S901 that the extended application 204 includes the unit that performs sharpness adjustment, the scan function extending unit 206 adds the information about the sharpness adjustment function to the scan function information 203 (S902). Thereafter, the edit control processing shown in FIG. 9 ends.

In the case of having been determined in S901 that the extended application 204 does not include the unit that performs sharpness adjustment, the edit control processing shown in FIG. 9 ends.

In this way, the scan function extending unit 206 first adds, to the scan function information 203, the function and options thereof that are not supported by the general purpose scan software 202 but are supported by both the scan apparatus 102 and the extended application 204. Furthermore, in the case where the scan apparatus 102 does not support the sharpness adjustment function and the extended application 204 includes the unit that performs sharpness adjustment, the scan function extending unit 206 adds the information about the sharpness adjustment function to the scan function information 203. By using this scan function information 203, based on scanning capabilities generated by this scan function information 203, the detailed setting screen 305b is displayed on the display unit 119. In this way, in the second embodiment, the setting items displayed on the detailed setting screen 305b are decided by using the extended application supported function list (the capability information of the extended application 204). As a result, even in the case where the scan apparatus 102 does not support the sharpness adjustment function, it is possible to accept the setting of the sharpness adjustment function from the user.

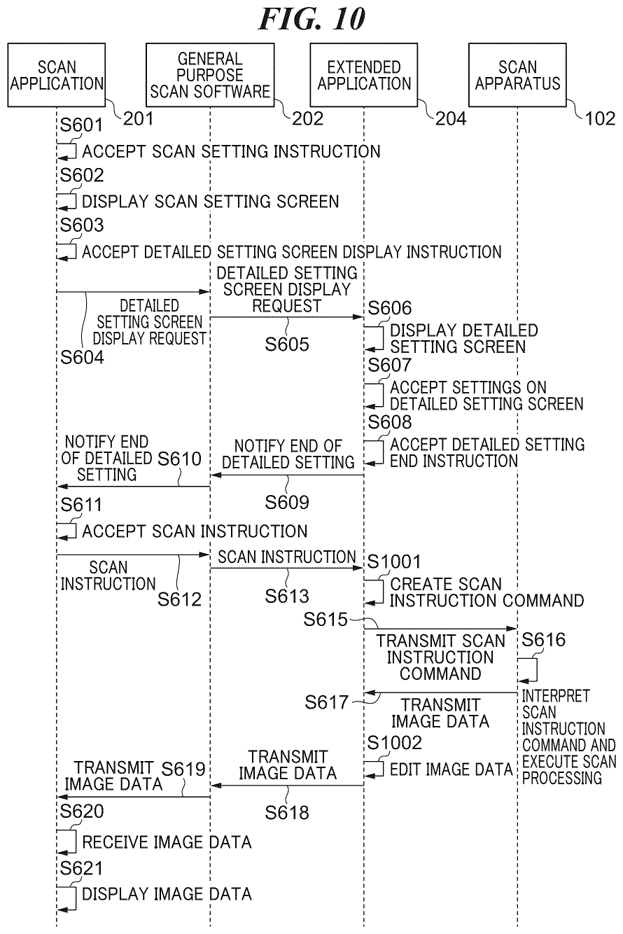

FIG. 10 is a sequence diagram that shows the procedure of a scan control processing executed in the communication system according to the second embodiment. It should be noted that the scan control processing shown in FIG. 10 is a processing similar to the scan control processing shown in FIG. 6 described above, and the following will particularly describe the differences from the scan control processing shown in FIG. 6 described above. The processes performed by the host computer 101 in FIG. 10 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 10 are realized by the CPU 191 of the scan apparatus 102 loading the program, which has been stored in the ROM 192 or the external storage device 199, into the RAM 193 and executing it. It should be noted that in the second embodiment, as shown in FIG. 2B described above, the scan control processing in the configuration, in which the host computer 101 includes the extended application 204, will be described. In addition, in the scan control processing shown in FIG. 10, it is assumed that the edit control processing of FIG. 9 described above has already been executed. Through this edit control processing, the options of the sharpness adjustment function that is not supported by the general purpose scan software 202 and the scan apparatus 102 but is supported by the extended application 204 have been added to the scan function information 203.

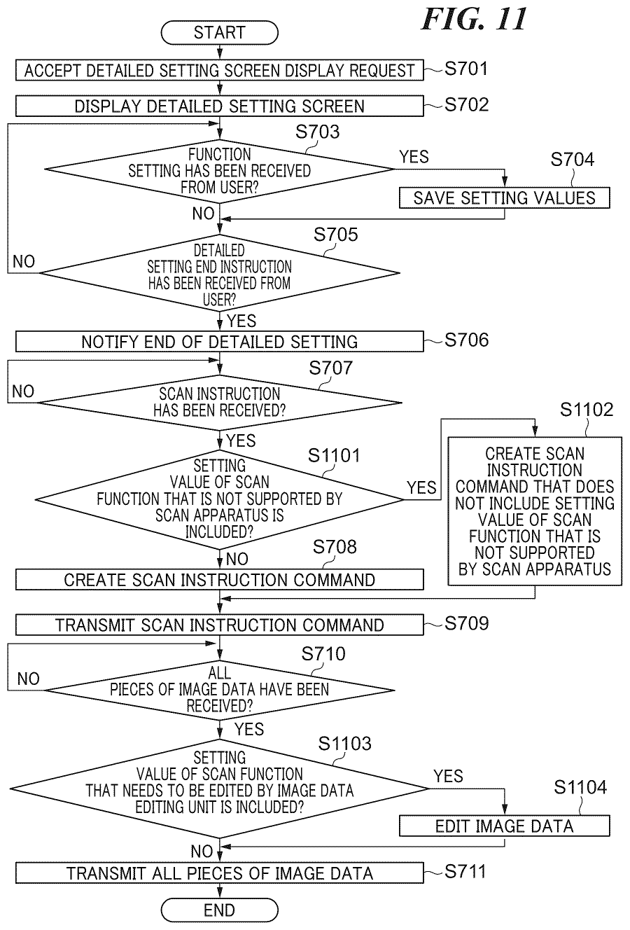

As shown in FIG. 10, first, S601 to S613 that have been described are performed. Next, in S1001, the extended application 204 creates a scan instruction command. It should be noted that the details of creating the scan instruction command will be described with reference to a flowchart shown in FIG. 11. Next, S615 to S617 that have been described are performed.

Next, in S1002, the extended application 204 causes the image data editing unit 207 to edit the image data that has been received from the scan apparatus 102. It should be noted that the details of editing the image data that has been received from the scan apparatus 102 will be described with reference to the flowchart shown in FIG. 11. Thereafter, S618 to S621 that have been described are performed, and the scan control processing shown in FIG. 10 ends.

Next, a scan instruction command generation processing executed by the extended application 204 according to the second embodiment will be described. This scan instruction command generation processing includes the above-described processes of S606, S607, S608, S609, S1001, S615, S1002, and S618.

FIG. 11 is the flowchart that shows the procedure of the scan instruction command generation processing executed by the extended application 204 according to the second embodiment. It should be noted that the scan instruction command generation processing shown in FIG. 11 is a processing similar to the scan instruction command generation processing shown in FIG. 7 described above, and the following will particularly describe the differences from the scan instruction command generation processing shown in FIG. 7 described above. It should be noted that similar to the scan instruction command generation processing shown in FIG. 7 described above, the scan instruction command generation processing shown in FIG. 11 is also realized by the CPU 111 executing the program of the extended application 204 that has been loaded from the external storage device 114 into the RAM 113.

As shown in FIG. 11, first, S701 to S707 that have been described are performed. When the scan instruction is received (YES in S707), the extended application 204 obtains the capability information of the scan apparatus 102 from the shared information 208. It should be noted that in the case where the shared information 208 does not include the capability information of the scan apparatus 102, the scan function extending unit 206 of the extended application 204 may request the capability information from the scan apparatus 102 and save it in the shared information 208.

Next, in S1101, the extended application 204 determines whether or not a setting value of a scan function that is not supported by the scan apparatus 102 is included in the scan setting information based on the obtained capability information.

In the case of having been determined in S1101 that the setting value of the scan function that is not supported by the scan apparatus 102 is not included in the scan setting information, the scan instruction command generation processing shown in FIG. 11 proceeds to S708, and then proceeds to S709.

In the case of having been determined in S1101 that the setting value of the scan function that is not supported by the scan apparatus 102 is included in the scan setting information, the scan instruction command generation processing shown in FIG. 11 proceeds to S1102. In S1102, the extended application 204 creates a scan instruction command that does not include the setting value of the scan function that is not supported by the scan apparatus 102. In the second embodiment, the scan instruction command that has been created in S1102 does not include the setting values of the sharpness adjustment function that is not supported by the scan apparatus 102. Next, the scan instruction command generation processing shown in FIG. 11 proceeds to S709 described above, and the created scan instruction command is transmitted to the scan apparatus 102.

Next, the scan instruction command generation processing shown in FIG. 11 proceeds to S710. When all pieces of the image data have been received from the scan apparatus 102 (YES in S710), the scan instruction command generation processing shown in FIG. 11 proceeds to S1103.

In S1103, the extended application 204 determines whether or not the setting value of the scan function that needs to be edited by the image data editing unit 207 is included in the scan setting information. The setting value of the scan function that needs to be edited by the image data editing unit 207 is, for example, the setting value of the sharpness adjustment function.

In the case of having been determined in S1103 that the setting value of the scan function that needs to be edited by the image data editing unit 207 is not included in the scan setting information, the scan instruction command generation processing shown in FIG. 11 proceeds to S711. In S711, the image data received from the scan apparatus 102 (all pieces of the image data that have been received from the scan apparatus 102) is transmitted directly to the general purpose scan software 202. Thereafter, the scan instruction command generation processing shown in FIG. 11 ends.

In the case of having been determined in S1103 that the setting value of the scan function that needs to be edited by the image data editing unit 207 is included in the scan setting information, the scan instruction command generation processing shown in FIG. 11 proceeds to S1104.

In S1104, the extended application 204 causes the image data editing unit 207 to edit the image data that has been received from the scan apparatus 102. Specifically, with respect to the image data that has been received from the scan apparatus 102, the image data editing unit 207 performs sharpness adjustment corresponding to the adjustment level of the text area for the text area, and performs sharpness adjustment corresponding to the adjustment level of the photograph area/the image area for the photograph area and the image area. Thereafter, the scan instruction command generation processing shown in FIG. 11 proceeds to S711, and the image data for which the sharpness adjustment has been performed in S1104 is transmitted to the general purpose scan software 202. Thereafter, the scan instruction command generation processing shown in FIG. 11 ends.

In the second embodiment described above, in the case of having been determined that the scan apparatus 102 does not support the sharpness adjustment function, the extended application 204 causes to transmit the scan instruction command that does not include the setting values that have been set on the detailed setting screen 305b. In addition, the extended application 204 performs the sharpness adjustment with respect to the image data that has been generated by the scan processing executed by the scan apparatus 102 in accordance with this scan instruction command. As a result, even in the case where the scan apparatus 102 does not support the sharpness adjustment function, it is possible to allow the user to use the sharpness adjustment function.

It should be noted that in the second embodiment described above, although the configuration has been described in which the scan instruction command that does not include the setting values of the sharpness adjustment function that is not supported by the scan apparatus 102 is transmitted to the scan apparatus 102, the present invention is not limited to this configuration. Even in the case where the scan apparatus 102 obtains a scan instruction command that includes the setting value of the scan function that is not supported by the scan apparatus 102, the scan apparatus 102 is not able to interpret the setting value of this scan function and will not use this scan function in the scan processing. In other words, even in the case where the scan apparatus 102 obtains the scan instruction command that includes the setting value of this scan function, the scan apparatus 102 executes a scan processing equivalent to a scan processing corresponding to a scan instruction command that does not include the setting value of this scan function. Therefore, a configuration may be adopted in which the scan instruction command that includes the setting values of the sharpness adjustment function that is not supported by the scan apparatus 102 is transmitted to the scan apparatus 102.

Next, programs, a communication system, an information processing apparatus, and a control method for the information processing apparatus according to a third embodiment of the present invention will be described. The third embodiment is basically the same as the first embodiment described above in terms of configuration and operation, but differs from the first embodiment described above in that the extended application 204 edits a scan instruction command created by the general purpose scan software 202. Therefore, descriptions of overlapping configurations and operations will be omitted, and only different configurations and operations will be described below.

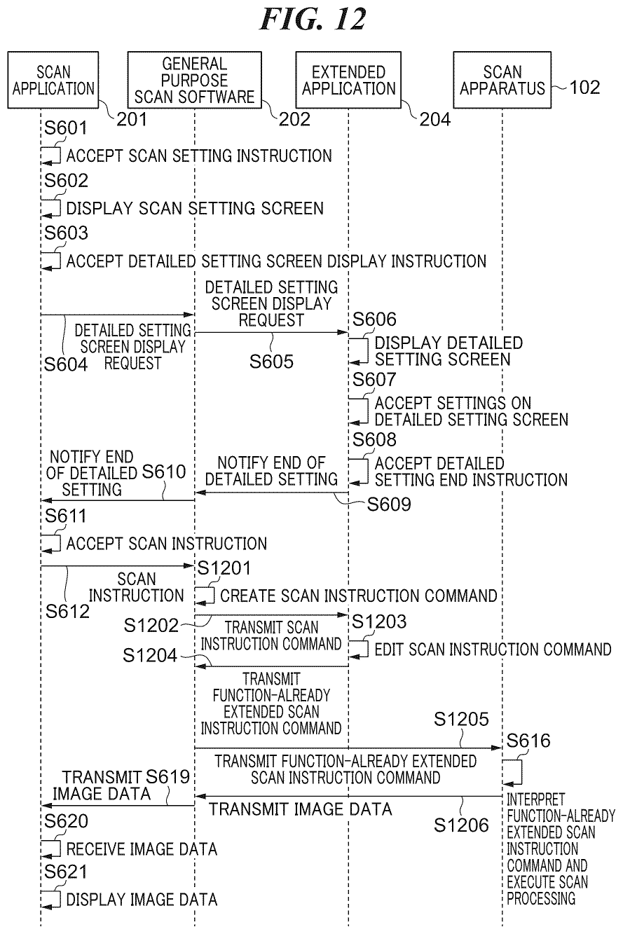

FIG. 12 is a sequence diagram that shows the procedure of a scan control processing executed in the communication system according to the third embodiment. It should be noted that the scan control processing shown in FIG. 12 is a processing similar to the scan control processing shown in FIG. 6 described above, and the following will particularly describe the differences from the scan control processing shown in FIG. 6 described above. The processes performed by the host computer 101 in FIG. 12 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 12 are realized by the CPU 191 of the scan apparatus 102 loading the program, which has been stored in the ROM 192 or the external storage device 199, into the RAM 193 and executing it. It should be noted that in the scan control processing shown in FIG. 12, as shown in FIG. 2B described above, the scan control processing in the configuration, in which the host computer 101 includes the extended application 204, will be described. In addition, in the scan control processing shown in FIG. 12, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 12, first, S601 to S612 that have been described are performed. Next, in S1201, the general purpose scan software 202 creates a scan instruction command. It should be noted that the scan instruction command created in S1201 does not include a setting value of a scan function that is not supported by the general purpose scan software 202, such as the sharpness adjustment function.

Next, in S1202, the general purpose scan software 202 transmits the created scan instruction command to the extended application 204.

Next, in S1203, the extended application 204 edits the received scan instruction command. Specifically, with respect to the received scan instruction command, the extended application 204 performs the addition of an instruction command for the scan function that is not supported by the general purpose scan software 202, or the modification of an existing instruction. Here, the scan instruction command that has been created by the general purpose scan software 202 in S1201 does not include the setting value of the scan function that is not supported by the general purpose scan software 202, for example, the setting values of the sharpness adjustment function. Therefore, in S1203, the setting values that have been set on the detailed setting screen 305b (the setting values of the sharpness adjustment function) are added to the received scan instruction command. In the following, the scan instruction command that has been obtained in S1203 is referred to as a function-already extended scan instruction command.

Next, in S1204, the extended application 204 transmits the function-already extended scan instruction command to the general purpose scan software 202.

In S1205, the general purpose scan software 202 transmits the function-already extended scan instruction command to the scan apparatus 102. Next, S616 described above is performed, and the scan apparatus 102 interprets the function-already extended scan instruction command and executes the scan processing.

Next, in S1206, the scan apparatus 102 transmits the generated image data to the general purpose scan software 202. Thereafter, S619 to S621 that have been described are performed, and the scan control processing shown in FIG. 12 ends.

In the third embodiment described above, the extended application 204 adds, to the scan instruction command that has been created by the general purpose scan software 202, the setting values of the sharpness adjustment function that have been set on the detailed setting screen 305b. As a result, the scan apparatus 102 becomes capable of being caused to execute the scan processing with the setting values that have been set on the detailed setting screen 305b, and therefore it is possible to provide, to the user, the image data, with respect to which the sharpness adjustment has been performed with the setting values that have been set on the detailed setting screen 305b.

Next, programs, a communication system, an information processing apparatus, and a control method for the information processing apparatus according to a fourth embodiment of the present invention will be described. The fourth embodiment is basically the same as the first embodiment described above in terms of configuration and operation. However, the fourth embodiment differs from the first embodiment described above in that the extended application 204 edits a scan instruction command created by the general purpose scan software 202 and the scan apparatus 102 does not support the sharpness adjustment function. Therefore, descriptions of overlapping configurations and operations will be omitted, and only different configurations and operations will be described below.

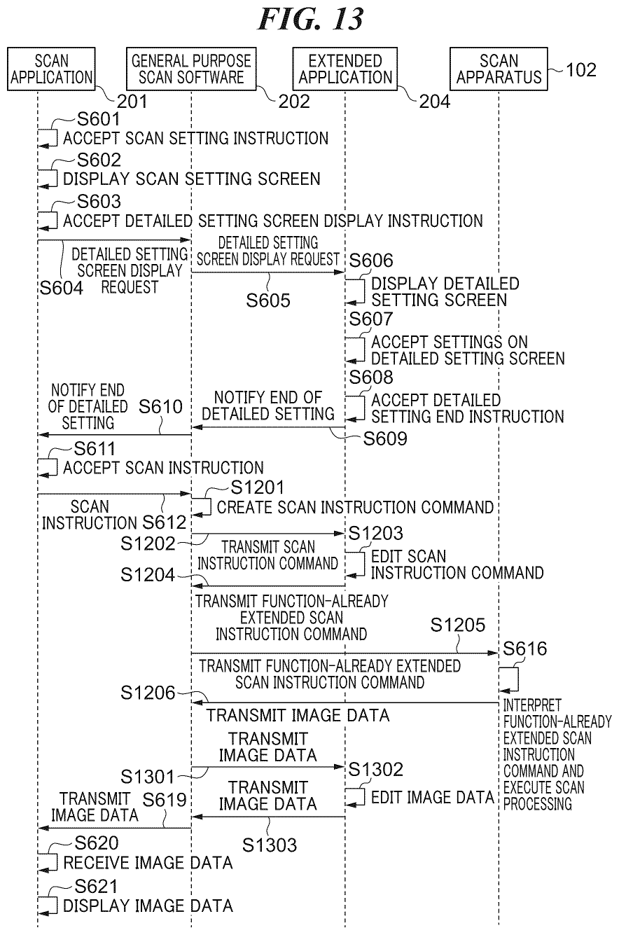

FIG. 13 is a sequence diagram that shows the procedure of a scan control processing executed in the communication system according to the fourth embodiment. It should be noted that in the fourth embodiment, it is assumed that the scan apparatus 102 does not support the sharpness adjustment function. The scan control processing shown in FIG. 13 is a processing similar to the scan control processing shown in FIG. 10 described above and the scan control processing shown in FIG. 12 described above, and the following will particularly describe the differences from the scan control processing shown in FIG. 10 described above and the scan control processing shown in FIG. 12 described above. The processes performed by the host computer 101 in FIG. 13 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 13 are realized by the CPU 191 of the scan apparatus 102 loading the program, which has been stored in the ROM 192 or the external storage device 199, into the RAM 193 and executing it. It should be noted that in the scan control processing shown in FIG. 13, as shown in FIG. 2B described above, the scan control processing in the configuration, in which the host computer 101 includes the extended application 204, will be described. In addition, in the scan control processing shown in FIG. 13, it is assumed that the edit control processing of FIG. 9 described above has already been executed. Through this edit control processing, the options of the sharpness adjustment function that is not supported by the general purpose scan software 202 and the scan apparatus 102 but is supported by the extended application 204 have been added to the scan function information 203.

As shown in FIG. 13, first, S601 to S612 that have been described are performed, and then S1201 to S1205, S616, and S1206 that have been described are performed. It should be noted that in the fourth embodiment, a configuration will be described in which the scan instruction command obtained by editing in S1203 does not include the setting values of the sharpness adjustment function that is not supported by the scan apparatus 102 and is supported by the extended application 204, the present invention is not limited to this configuration. In the case where the scan apparatus 102 does not support the sharpness adjustment function, even if the scan apparatus 102 obtains a scan instruction command that includes the setting values of the sharpness adjustment function, the scan apparatus 102 is not able to interpret the setting values of the sharpness adjustment function. The scan apparatus 102 performs the scan processing by using setting values other than the setting values of the sharpness adjustment function, from among setting values included in the scan instruction command. In this way, even if the scan apparatus 102 that does not support the sharpness adjustment function obtains a scan instruction command that includes the setting values of the sharpness adjustment function, the same scan processing is executed as in the case of having obtained a scan instruction command that does not include the setting values of the sharpness adjustment function. For this reason, in the fourth embodiment, the scan instruction command obtained by editing in S1203 may include the setting values of the sharpness adjustment function.

Next, in S1301, the general purpose scan software 202 transmits, to the extended application 204, the image data that has been received from the scan apparatus 102.

Next, in S1302, similar to S1002 described above, the extended application 204 causes the image data editing unit 207 to edit the image data that has been received from the scan apparatus 102. Specifically, with respect to the image data that has been received from the scan apparatus 102, the image data editing unit 207 performs sharpness adjustment corresponding to the adjustment level of the text area for the text area, and performs sharpness adjustment corresponding to the adjustment level of the photograph area/the image area for the photograph area and the image area.

Next, in S1303, the extended application 204 transmits, to the general purpose scan software 202, the image data that has been obtained in S1302. Thereafter, S619 to S621 that have been described are performed.

With the configuration of the fourth embodiment, it is possible to allow the user to use the sharpness adjustment function.

Next, programs, a communication system, an information processing apparatus, and a control method for the information processing apparatus according to a fifth embodiment of the present invention will be described. The fifth embodiment is basically the same as the first embodiment described above in terms of configuration and operation, but differs from the first embodiment described above in that an extended scan instruction command is created separately without extending a standard scan instruction command conforming to a standard protocol. Therefore, descriptions of overlapping configurations and operations will be omitted, and only different configurations and operations will be described below.

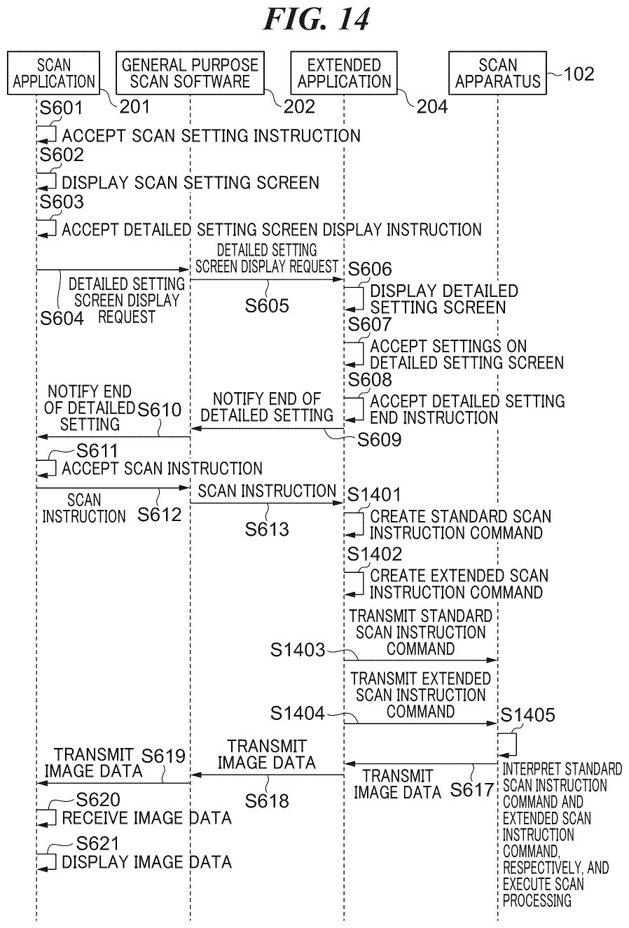

FIG. 14 is a sequence diagram that shows the procedure of a scan control processing executed in the communication system according to the fifth embodiment. It should be noted that the scan control processing shown in FIG. 14 is a processing similar to the scan control processing shown in FIG. 6 described above, and the following will particularly describe the differences from the scan control processing shown in FIG. 6 described above. The processes performed by the host computer 101 in FIG. 14 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 14 are realized by the CPU 191 of the scan apparatus 102 loading the program, which has been stored in the ROM 192 or the external storage device 199, into the RAM 193 and executing it. It should be noted that in the scan control processing shown in FIG. 14, as shown in FIG. 2B described above, the scan control processing in the configuration, in which the host computer 101 includes the extended application 204, will be described. In addition, in the scan control processing shown in FIG. 14, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 14, first, S601 to S613 that have been described are performed. Next, in S1401, the extended application 204 creates a standard scan instruction command conforming to the standard protocol. It should be noted that the standard scan instruction command that has been created in S1401 does not record any scan function that is not supported by the standard protocol. For example, in the case where the sharpness adjustment function is not supported by the standard protocol, the standard scan instruction command does not include the setting values of the sharpness adjustment function that have been set on the detailed setting screen 305b.

Next, in S1402, the extended application 204 creates an extended scan instruction command for implementing a scan function that is not supported by the standard protocol. The extended scan instruction command includes, for example, setting value(s) of a scan function that is not supported by the standard protocol but is supported by the extended application 204. For example, in the case where the sharpness adjustment function is not supported by the standard protocol, the extended scan instruction command includes the setting values of the sharpness adjustment function that have been set on the detailed setting screen 305b.

Next, in S1403, the extended application 204 transmits the standard scan instruction command to the scan apparatus 102. In addition, in S1404, the extended application 204 transmits the extended scan instruction command to the scan apparatus 102.

Next, in S1405, the scan apparatus 102 interprets the received standard scan instruction command and the received extended scan instruction command, respectively, and executes the scan processing. Thereafter, S617 to S621 that have been described are performed, and the scan control processing shown in FIG. 14 ends.

Here, a scan instruction command generation processing executed by the extended application 204 according to the fifth embodiment will be described. This scan instruction command generation processing includes the above-described processes of S606, S607, S608, S609, S1401, S1402, S1403, S1404, and S618.

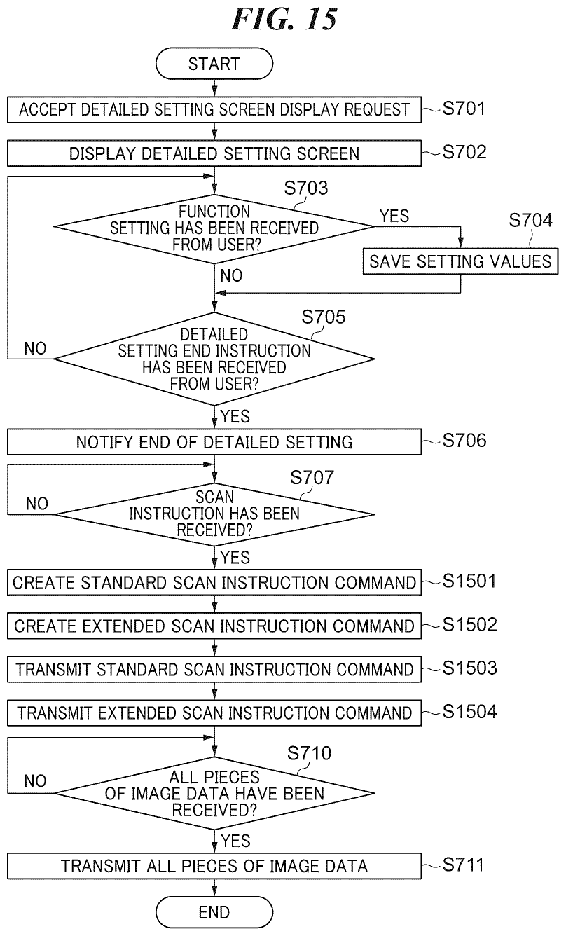

FIG. 15 is a flowchart that shows the procedure of the scan instruction command generation processing executed by the extended application 204 according to the fifth embodiment. It should be noted that the scan instruction command generation processing shown in FIG. 15 is a processing similar to the scan instruction command generation processing shown in FIG. 7 described above, and the following will particularly describe the differences from the scan instruction command generation processing shown in FIG. 7 described above. Similar to the scan instruction command generation processing shown in FIG. 7 described above, the scan instruction command generation processing shown in FIG. 15 is also realized by the CPU 111 executing the program of the extended application 204 that has been loaded from the external storage device 114 into the RAM 113.

As shown in FIG. 15, first, S701 to S707 that have been described are performed. When the scan instruction is received (YES in S707), in S1501, the extended application 204 creates a standard scan instruction command conforming to the standard protocol (for example, see S1401 described above). Next, in S1502, the extended application 204 creates an extended scan instruction command for implementing a scan function that is not supported by the standard protocol (for example, see S1402 described above). Next, in S1503, the extended application 204 transmits the standard scan instruction command that has been created in S1501 to the scan apparatus 102 (for example, see S1403 described above). Next, in S1504, the extended application 204 transmits the extended scan instruction command that has been created in S1502 to the scan apparatus 102 (for example, see S1404 described above). Thereafter, S710 to S711 that have been described are performed, and the scan instruction command generation processing shown in FIG. 15 ends.

In the fifth embodiment described above, the standard scan instruction command conforming to the standard protocol and the extended scan instruction command for implementing the scan function that is not supported by the standard protocol are transmitted to the scan apparatus 102, respectively. As a result, it is possible to reflect a setting for the scan function that is not supported by the standard protocol in the scan instruction command.

Next, programs, a communication system, an information processing apparatus, and a control method for the information processing apparatus according to a sixth embodiment of the present invention will be described. The sixth embodiment is basically the same as the first embodiment described above in terms of configuration and operation, but differs from the first embodiment described above in that a preview image is displayed on the detailed setting screen 305b. Therefore, descriptions of overlapping configurations and operations will be omitted, and only different configurations and operations will be described below.

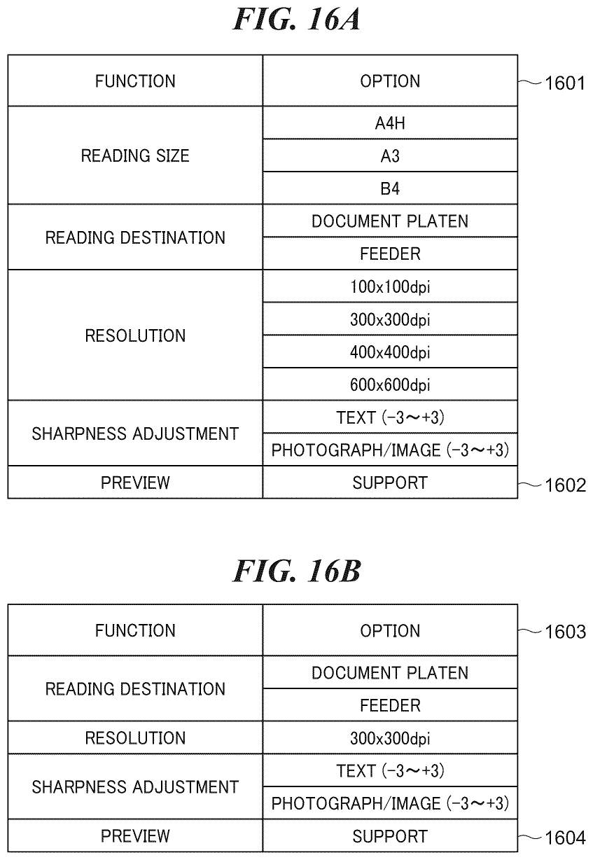

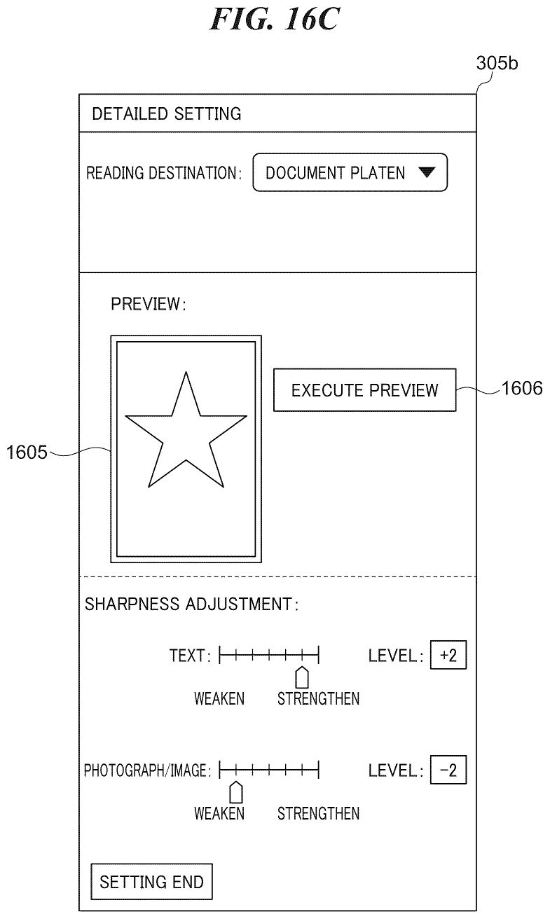

A table 1601 shown in FIG. 16A is an example of capability information that has been obtained from the scan apparatus 102 according to the sixth embodiment. As shown in the table 1601, it is possible from the scan apparatus 102 to obtain information 1602 indicating that the scan apparatus 102 supports a preview function.

A table 1603 shown in FIG. 16B is an example of an extended application supported function list. In the sixth embodiment, as shown in information 1604 in the table 1603, the extended application 204 also supports the preview function.

FIG. 16C is a diagram that shows an example of a detailed setting screen 305b on which the preview function is capable of being used. The detailed setting screen 305b shown in FIG. 16C includes, in addition to the control 306b, the setting end button 307b, and the controls 308b to 311b that have been described above, an area 1605 for displaying a preview image, and a control 1606 for issuing an instruction to display a preview image (a preview display instruction).

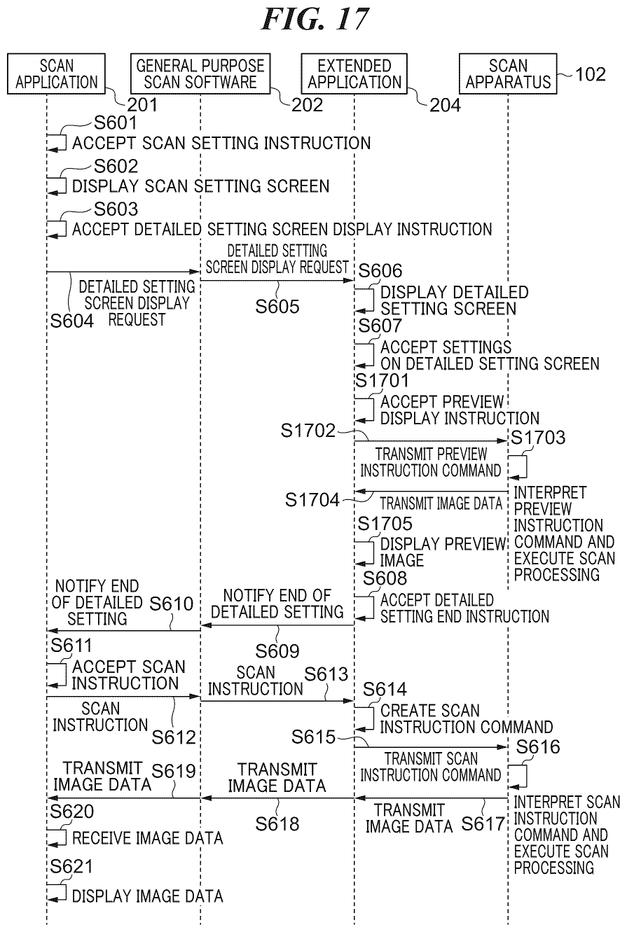

FIG. 17 is a sequence diagram that shows the procedure of a scan control processing executed in the communication system according to the sixth embodiment. It should be noted that the scan control processing shown in FIG. 17 is a processing similar to the scan control processing shown in FIG. 6 described above, and the following will particularly describe the differences from the scan control processing shown in FIG. 6 described above. The processes performed by the host computer 101 in FIG. 17 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 17 are realized by the CPU 191 of the scan apparatus 102 loading the program, which has been stored in the ROM 192 or the external storage device 199, into the RAM 193 and executing it. It should be noted that in FIG. 17, as shown in FIG. 2B described above, the scan control processing in the configuration, in which the host computer 101 includes the extended application 204, will be described. In addition, in the scan control processing shown in FIG. 17, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 17, first, S601 to S607 that have been described are performed. Next, in S1701, the extended application 204 accepts a preview display instruction. The user is able to operate the pointing device 117 and/or the keyboard 118 to select the control 1606 to issue the preview display instruction.

Next, in S1702, the extended application 204 transmits, to the scan apparatus 102, a preview instruction command that is a scan instruction for previewing. In S1702, for example, a preview instruction command for causing to execute a scan processing with the setting values of the sharpness adjustment function that have been set on the detailed setting screen 305b at this time point is transmitted to the scan apparatus 102.

Next, in S1703, the scan apparatus 102 interprets the received preview instruction command and executes a scan processing. In this scan processing, for example, with respect to image data that has been generated by reading a document, the scan apparatus 102 performs sharpness adjustment corresponding to the setting values that have been set by the user on the detailed setting screen 305b at the time point of S1702.

Next, in S1704, the scan apparatus 102 transmits, to the extended application 204, image data that has been generated by the scan processing performed in S1703.

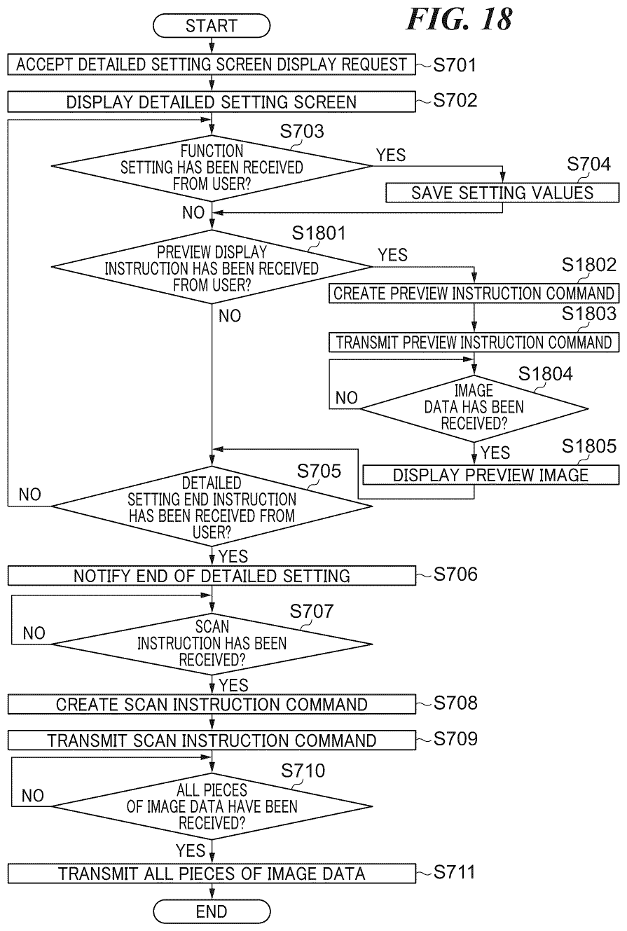

Next, in S1705, the extended application 204 uses the received image data to cause to display a preview image on the area 1605 of the detailed setting screen 305b. It should be noted that the display of the preview image will be described with reference to a flowchart shown in FIG. 18. Next, S608 to S621 that have been described are performed, and the scan control processing shown in FIG. 17 ends.

Next, a scan instruction command generation processing executed by the extended application 204 according to the sixth embodiment will be described. This scan instruction command generation processing includes the above-described processes of S606, S607, S1701, S1702, S1705, S608, S609, S614, S615, and S618.

FIG. 18 is the flowchart that shows the procedure of the scan instruction command generation processing executed by the extended application 204 according to the sixth embodiment. It should be noted that the scan instruction command generation processing shown in FIG. 18 is a processing similar to the scan instruction command generation processing shown in FIG. 7 described above, and the following will particularly describe the differences from the scan instruction command generation processing shown in FIG. 7 described above. It should be noted that similar to the scan instruction command generation processing shown in FIG. 7 described above, the scan instruction command generation processing shown in FIG. 18 is also realized by the CPU 111 executing the program of the extended application 204 that has been loaded from the external storage device 114 into the RAM 113.

As shown in FIG. 18, first, S701 to S704 that have been described are performed. Next, in S1801, the scan setting screen extending unit 205 of the extended application 204 determines whether or not a preview display instruction has been received from the user.

In the case of having been determined in S1801 that a preview display instruction has not been received from the user, the scan instruction command generation processing shown in FIG. 18 proceeds to S705. The subsequent processing is similar to the scan instruction command generation processing shown in FIG. 7 described above.

In the case of having been determined in S1801 that a preview display instruction has been received from the user, the scan instruction command generation processing shown in FIG. 18 proceeds to S1802. In S1802, the extended application 204 creates a preview instruction command based on the setting values that have been saved in S704. It should be noted that in S1802, the preview instruction command is created by the same method as in the above-described creation of the scan instruction command in S708.

Next, in S1803, the extended application 204 transmits the preview instruction command to the scan apparatus 102 (for example, see S1702 described above). Next, in S1804, the extended application 204 determines whether or not the image data has been received from the scan apparatus 102. The extended application 204 waits until the image data is received from the scan apparatus 102, and when the image data is received from the scan apparatus 102 (YES in S1804), the scan instruction command generation processing shown in FIG. 18 proceeds to S1805.

In S1805, the extended application 204 uses the received image data to cause to display a preview image on the area 1605 of the detailed setting screen 305b. Thereafter, the scan instruction command generation processing shown in FIG. 18 proceeds to S705. The subsequent processing is similar to the scan instruction command generation processing shown in FIG. 7 described above.

In the sixth embodiment described above, a preview image is displayed by using the setting values that have been set on the detailed setting screen 305b. As a result, the user is able to confirm (check) the state of the sharpness of the image data by a pre-scan and then instruct the execution of a main scan.

In addition, in the sixth embodiment described above, in response to having received a preview display instruction from the user, a preview instruction command for causing the scan apparatus 102 to execute a scan processing for generating image data to be used for displaying a preview image is outputted. As a result, it is possible to display a preview image corresponding to the setting values that have been set on the detailed setting screen 305b by using the image data that has been generated by the scan apparatus 102.

In addition, in the sixth embodiment described above, the preview image is displayed on the area 1605 of the detailed setting screen 305b. As a result, it is possible for the user to easily confirm (check) on the same screen the sharpness corresponding to the setting values that have been set on the detailed setting screen 305b.

It should be noted that in the sixth embodiment described above, the preview image may be displayed on a screen different from the detailed setting screen 305b. For example, in the case where the control 1606 for issuing a preview display instruction has been selected by the user, the screen of the display unit 119 switches from the detailed setting screen 305b to a preview screen (not shown). On this preview screen, the preview image is displayed, for example, in full screen. As a result, it is possible for the user to confirm (check) in more detail the sharpness corresponding to the setting values that have been set on the detailed setting screen 305b.

In addition, in the sixth embodiment described above, the host computer 101 may be configured to discard the preview image when the host computer 101 has accepted a detailed setting end instruction from the user in S608 or when the host computer 101 has accepted a detailed setting cancel instruction from the user in S608.

In addition, in the sixth embodiment described above, the preview image may be retained until image data is obtained by a main scan so that the preview image is capable of being displayed again in accordance with an instruction from the user.

In addition, in the sixth embodiment described above, in the case where the user has changed the setting values of the sharpness adjustment function after the preview image is displayed, the preview image may be edited by the image data editing unit 207 and the edited preview image may be displayed.

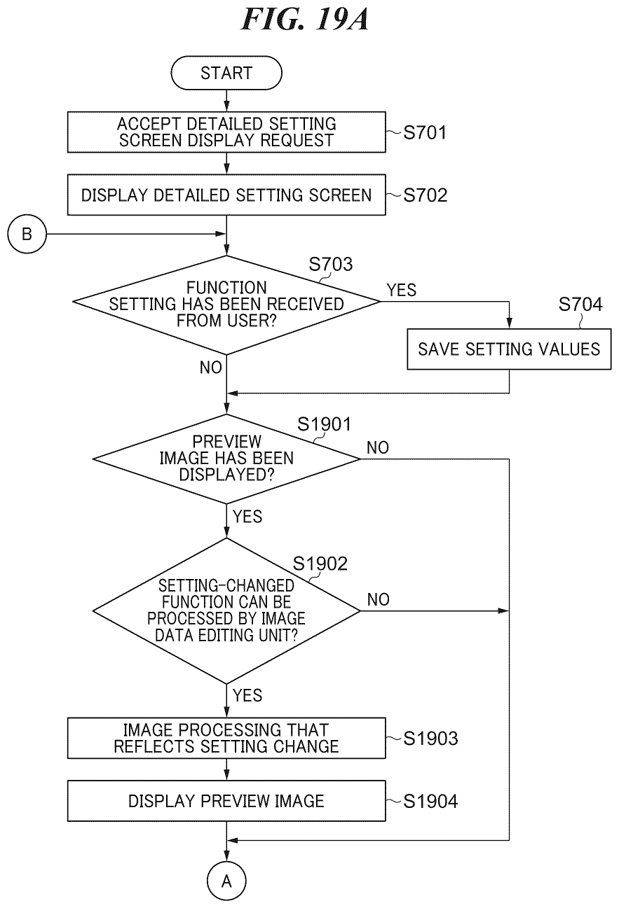

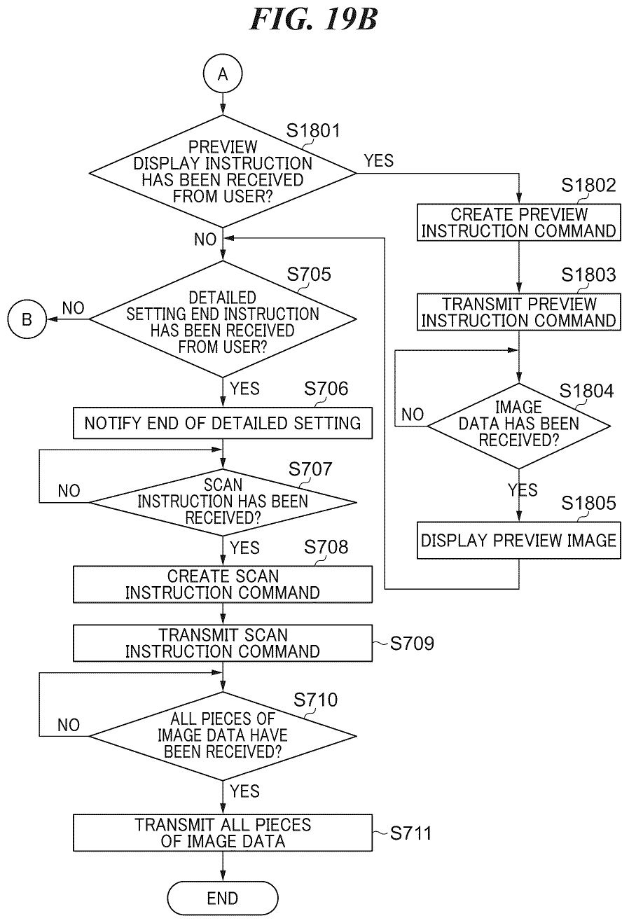

FIG. 19A and FIG. 19B show a flowchart that shows another procedure of the scan instruction command generation processing executed by the extended application 204 according to the sixth embodiment. It should be noted that the scan instruction command generation processing shown in FIG. 19A and FIG. 19B is a processing similar to the scan instruction command generation processing shown in FIG. 18 described above, and the following will particularly describe the differences from the scan instruction command generation processing shown in FIG. 18 described above. It should be noted that similar to the scan instruction command generation processing shown in FIG. 18 described above, the scan instruction command generation processing shown in FIG. 19A and FIG. 19B is also realized by the CPU 111 executing the program of the extended application 204 that has been loaded from the external storage device 114 into the RAM 113.

As shown in FIG. 19A and FIG. 19B, first, S701 to S704 that have been described are performed. Next, in S1901, the extended application 204 determines whether or not a preview image has been displayed.

In the case of having been determined in S1901 that a preview image has not been displayed, the scan instruction command generation processing shown in FIG. 19A and FIG. 19B proceeds to S1801. The subsequent processing is similar to the scan instruction command generation processing shown in FIG. 18 described above.

In the case of having been determined in S1901 that a preview image has been displayed, the scan instruction command generation processing shown in FIG. 19A and FIG. 19B proceeds to S1902. In S1902, the extended application 204 determines whether or not the function whose setting has been changed in S703 is capable of being processed by the image data editing unit 207. For example, in the case where the function whose setting has been changed in S703 is the sharpness adjustment function, since the sharpness adjustment function is capable of being processed by the image data editing unit 207, it is determined that the function whose setting has been changed in S703 is capable of being processed by the image data editing unit 207. In this case, the scan instruction command generation processing shown in FIG. 19A and FIG. 19B proceeds to S1903.

In S1903, the image data editing unit 207 performs image processing that reflects the setting change. For example, in the case where the function whose setting has been changed in S703 is the sharpness adjustment function, the image data editing unit 207 performs the sharpness adjustment with the changed adjustment levels with respect to the image data that has been used to display the preview image.

Next, in S1904, the extended application 204 uses the image data, with respect to which the image processing has been performed, to cause to display a preview image on the area 1605 of the detailed setting screen 305b. Thereafter, the scan instruction command generation processing shown in FIG. 19A and FIG. 19B proceeds to S1801. The subsequent processing is similar to the scan instruction command generation processing shown in FIG. 18 described above.

In the case of having been determined in S1902 that the function whose setting has been changed in S703 is not capable of being processed by the image data editing unit 207, the scan instruction command generation processing shown in FIG. 19A and FIG. 19B proceeds to S1801. The subsequent processing is similar to the scan instruction command generation processing shown in FIG. 18 described above.

In the scan instruction command generation processing shown in FIG. 19A and FIG. 19B described above, in the case where the setting values have been changed on the detailed setting screen 305b in a state where a preview image has been displayed, with respect to the image data that has been used to display this preview image, a sharpness adjustment using the changed setting values is performed. This image data for which the sharpness adjustment has been performed is displayed as a preview image. As a result, it is possible to provide a preview image corresponding to the changed setting values without causing the scan apparatus 102 to execute a scan again.

Next, programs, a communication system, an information processing apparatus, and a control method for the information processing apparatus according to a seventh embodiment of the present invention will be described. The seventh embodiment is basically the same as the first embodiment described above in terms of configuration and operation, but differs from the first embodiment described above in that image data that has been used to display a preview image is capable of being saved according to an instruction from the user. Therefore, descriptions of overlapping configurations and operations will be omitted, and only different configurations and operations will be described below.

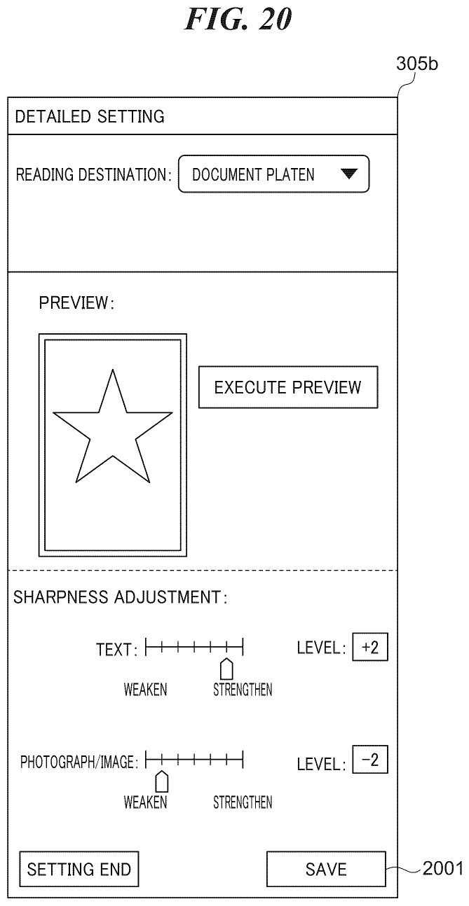

As shown in FIG. 20, a detailed setting screen 305b in the seventh embodiment includes a control 2001 for instructing saving of the image data that has been used to display a preview image. As a result, in the case where the preview image has the intended sharpness, the user is able to save the image data that has been used to display this preview image.

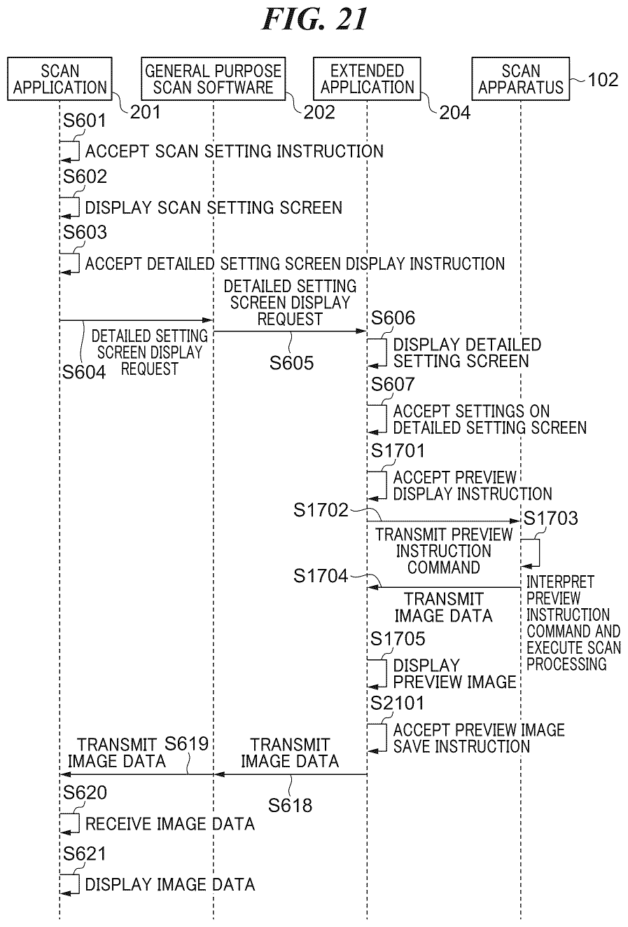

FIG. 21 is a sequence diagram that shows the procedure of a scan control processing executed in the communication system according to the seventh embodiment. It should be noted that the scan control processing shown in FIG. 21 is a processing similar to the scan control processing shown in FIG. 6 described above, and the following will particularly describe the differences from the scan control processing shown in FIG. 6 described above. The processes performed by the host computer 101 in FIG. 21 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 21 are realized by the CPU 191 of the scan apparatus 102 loading the program, which has been stored in the ROM 192 or the external storage device 199, into the RAM 193 and executing it. It should be noted that in FIG. 21, as shown in FIG. 2B described above, the scan control processing in the configuration, in which the host computer 101 includes the extended application 204, will be described. In addition, in the scan control processing shown in FIG. 21, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 21, first, S601 to S607 that have been described are performed, and next, S1701 to S1705 that have been described are performed. It should be noted that the detailed setting screen 305b on which a preview image has been displayed in S1705 includes the control 2001 for instructing saving of the image data that has been used to display the preview image.

Next, in S2101, the extended application 204 accepts an instruction to save a preview image (a preview image save instruction). The user is able to operate the pointing device 117 and/or the keyboard 118 to select the control 2001 to issue the preview image save instruction. When the preview image save instruction is accepted, the scan control processing shown in FIG. 21 proceeds to S618 described above, and the extended application 204 transfers, to the general purpose scan software 202, the image data that has been used to display the preview image. Thereafter, S619 to S621 that have been described are performed, and the scan control processing shown in FIG. 21 ends.

Next, a scan instruction command generation processing executed by the extended application 204 according to the seventh embodiment will be described. This scan instruction command generation processing includes the above-described processes of S606, S607, S1701, S1702, S1705, S2101, and S618.

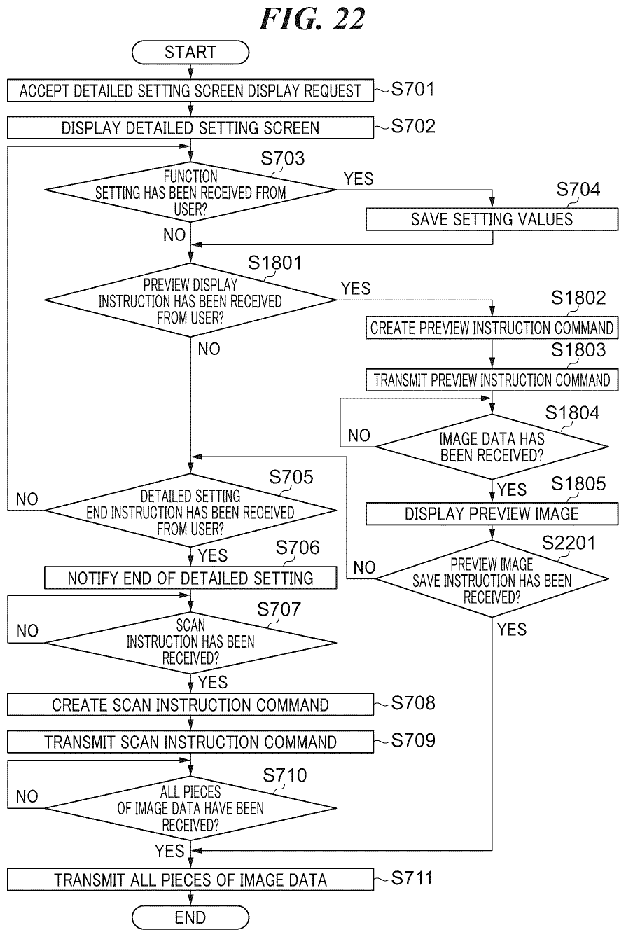

FIG. 22 is a flowchart that shows the procedure of the scan instruction command generation processing executed by the extended application 204 according to the seventh embodiment. It should be noted that the scan instruction command generation processing shown in FIG. 22 is a processing similar to the scan instruction command generation processing shown in FIG. 7 described above and the scan instruction command generation processing shown in FIG. 18 described above, and the following will particularly describe the differences from the scan instruction command generation processing shown in FIG. 7 described above and the scan instruction command generation processing shown in FIG. 18 described above. It should be noted that similar to the scan instruction command generation processing shown in FIG. 7 described above and the scan instruction command generation processing shown in FIG. 18 described above, the scan instruction command generation processing shown in FIG. 22 is also realized by the CPU 111 executing the program of the extended application 204 that has been loaded from the external storage device 114 into the RAM 113.

As shown in FIG. 22, first, S701 to S704 and S1801 that have been described are performed.

In the case of having been determined in S1801 that a preview display instruction has not been received from the user, the scan instruction command generation processing shown in FIG. 22 proceeds to S705. The subsequent processing is similar to the scan instruction command generation processing shown in FIG. 7 described above.

In the case of having been determined in S1801 that a preview display instruction has been received from the user, the scan instruction command generation processing shown in FIG. 22 proceeds to S1802. Next, S1803 to S1805 are performed. Next, in S2201, the scan setting screen extending unit 205 of the extended application 204 determines whether or not a preview image save instruction has been received from the user.

In the case of having been determined in S2201 that a preview image save instruction has not been received from the user, the scan instruction command generation processing shown in FIG. 22 proceeds to S705. The subsequent processing is similar to the scan instruction command generation processing shown in FIG. 7 described above.

In the case of having been determined in S2201 that a preview image save instruction has been received from the user, the scan instruction command generation processing shown in FIG. 22 proceeds to S711, and the extended application 204 transmits, to the general purpose scan software 202, the image data that has been used to display the preview image. Thereafter, the scan instruction command generation processing shown in FIG. 22 ends.

Next, programs, a communication system, an information processing apparatus, and a control method for the information processing apparatus according to an eighth embodiment of the present invention will be described. The eighth embodiment is basically the same as the first embodiment described above in terms of configuration and operation, but differs from the first embodiment described above in that a preview image is displayed by using image data that has been retained in advance by the extended application 204, rather than image data that has been obtained by reading a document. Therefore, descriptions of overlapping configurations and operations will be omitted, and only different configurations and operations will be described below.

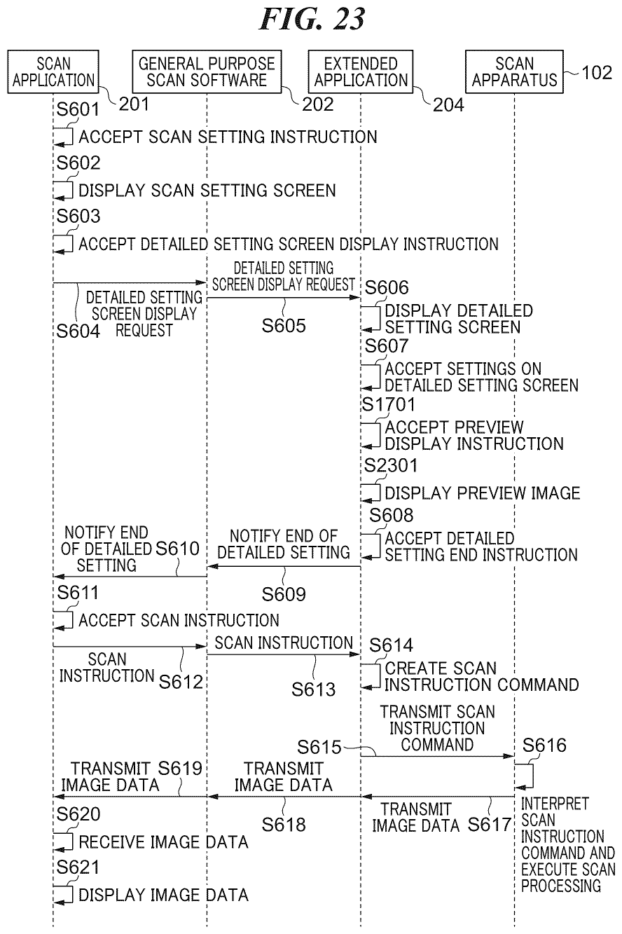

FIG. 23 is a sequence diagram that shows the procedure of a scan control processing executed in the communication system according to the eighth embodiment. It should be noted that the scan control processing shown in FIG. 23 is a processing similar to the scan control processing shown in FIG. 6 described above and the scan control processing shown in FIG. 17 described above, and the following will particularly describe the differences from the scan control processing shown in FIG. 6 described above and the scan control processing shown in FIG. 17 described above. The processes performed by the host computer 101 in FIG. 23 are realized by the CPU 111 loading the program of the scan application 201, the program of the general purpose scan software 202, and the program of the extended application 204 from the external storage device 114 into the RAM 113 and executing them. In addition, the processes performed by the scan apparatus 102 in FIG. 23 are realized by the CPU 191 of the scan apparatus 102 loading the program, which has been stored in the ROM 192 or the external storage device 199, into the RAM 193 and executing it. It should be noted that in FIG. 23, as shown in FIG. 2B described above, the scan control processing in the configuration, in which the host computer 101 includes the extended application 204, will be described. In addition, in the scan control processing shown in FIG. 23, it is assumed that the edit control processing of FIG. 4 described above has already been executed. Through this edit control processing, the options of the scan function (for example, the sharpness adjustment function) that is not supported by the general purpose scan software 202 but is supported by the scan apparatus 102 and the extended application 204 have been added to the scan function information 203.

As shown in FIG. 23, first, S601 to S607 and S1701 that have been described are performed.

Next, in S2301, the extended application 204 causes to display, on the area 1605 of the detailed setting screen 305b, a preview image corresponding to the setting values that have been set on the detailed setting screen 305b. In S2301, for example, from among a plurality of pieces of image data that have been stored in advance in the external storage device 114 or the like and are a plurality of pieces of image data for previewing corresponding to each adjustment level, image data (a piece of image data) corresponding to the setting values that have been set on the detailed setting screen 305b is displayed as a preview image. Alternatively, sharpness adjustment corresponding to the setting values that have been set on the detailed setting screen 305b is performed with respect to image data for previewing (a piece of image data for previewing) that has been stored in advance in the external storage device 114 or the like, and the image data for which the sharpness adjustment has been performed is displayed as a preview image. Thereafter, S608 to S621 are performed, and the scan control processing shown in FIG. 23 ends.

Next, a scan instruction command generation processing executed by the extended application 204 according to the eighth embodiment will be described. This scan instruction command generation processing includes the above-described processes of S606, S607, S1701, S2301, S608, S609, S614, S615, and S618.

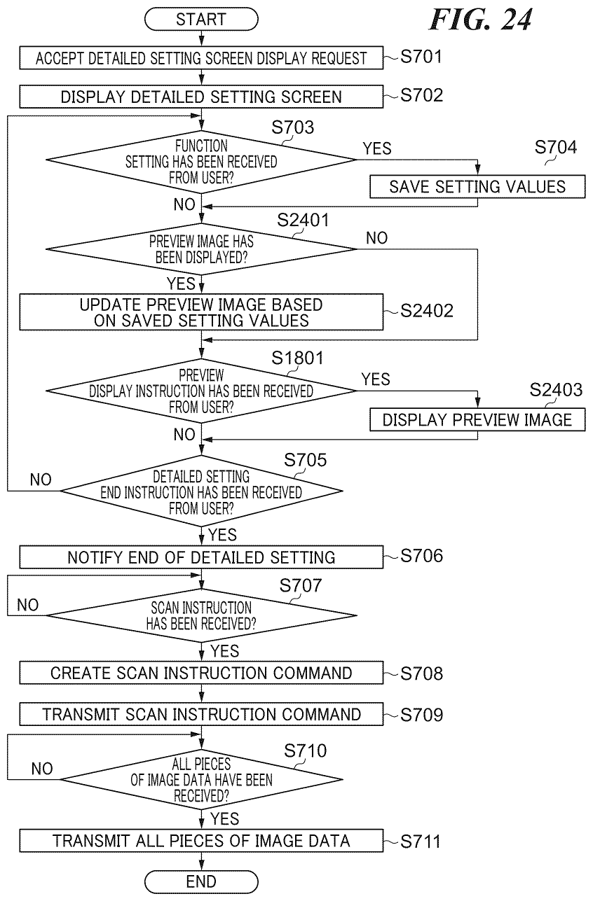

FIG. 24 is a flowchart that shows the procedure of the scan instruction command generation processing executed by the extended application 204 according to the eighth embodiment. It should be noted that the scan instruction command generation processing shown in FIG. 24 is a processing similar to the scan instruction command generation processing shown in FIG. 7 described above and the scan instruction command generation processing shown in FIG. 18 described above, and the following will particularly describe the differences from the scan instruction command generation processing shown in FIG. 7 described above and the scan instruction command generation processing shown in FIG. 18 described above. It should be noted that similar to the scan instruction command generation processing shown in FIG. 7 described above, the scan instruction command generation processing shown in FIG. 24 is also realized by the CPU 111 executing the program of the extended application 204 that has been loaded from the external storage device 114 into the RAM 113.

As shown in FIG. 24, first, S701 to S703 that have been described are performed.

In the case of having been determined in S703 that a function setting on the detailed setting screen 305b has been received from the user, the scan instruction command generation processing shown in FIG. 24 proceeds to S704, and then proceeds to S2401.

In the case of having been determined in S703 that a function setting on the detailed setting screen 305b has not been received from the user, the scan instruction command generation processing shown in FIG. 24 proceeds to S2401. In S2401, the extended application 204 determines whether or not a preview image has been displayed.

In the case of having been determined in S2401 that a preview image has not been displayed, the scan instruction command generation processing shown in FIG. 24 proceeds to S1801 described above.

In the case of having been determined in S2401 that a preview image has been displayed, the scan instruction command generation processing shown in FIG. 24 proceeds to S2402. In S2402, the extended application 204 updates the preview image based on the setting values that have been saved in S704. Specifically, the extended application 204 causes the image data editing unit 207 to perform sharpness adjustment corresponding to the setting values that have been saved in S704 with respect to the image data that has been used to display the preview image. The extended application 204 causes to display, on the area 1605 of the detailed setting screen 305b, a preview image using the image data for which the sharpness adjustment has been performed. Next, the scan instruction command generation processing shown in FIG. 24 proceeds to S1801 described above.

In the case of having been determined in S1801 that a preview display instruction has not been received from the user, the scan instruction command generation processing shown in FIG. 24 proceeds to S705. The subsequent processing is similar to the scan instruction command generation processing shown in FIG. 7 described above.

In the case of having been determined in S1801 that a preview display instruction has been received from the user, the scan instruction command generation processing shown in FIG. 24 proceeds to S2403. In S2403, the extended application 204 causes to display, on the area 1605 of the detailed setting screen 305b, a preview image corresponding to the setting values that have been saved in S704 (for example, see S2301 described above). Thereafter, the scan instruction command generation processing shown in FIG. 24 proceeds to S705. The subsequent processing is similar to the scan instruction command generation processing shown in FIG. 7 described above.

In the eighth embodiment described above, a preview image is displayed by using the image data that has been retained in advance by the extended application 204. In other words, there is no need to cause the scan apparatus 102 to execute a scan processing for generating image data to be used to display a preview image. As a result, although differing from actual image data, it is possible to allow the user to quickly confirm (check) a preview image corresponding to the setting values that have been set on the detailed setting screen 305b.

It should be noted that in the present embodiment, the capability information of the scan apparatus 102 may be used to decide whether the image data that has been generated by the scan apparatus 102 or the image data that has been retained in advance by the extended application 204 is to be used to display the preview image. For example, in the case where the capability information of the scan apparatus 102 includes, as shown in FIG. 16A, the information 1602 indicating that the scan apparatus 102 supports the preview function, it is decided that the image data that has been generated by the scan apparatus 102 is to be used to display the preview image. On the other hand, in the case where the capability information of the scan apparatus 102 does not include the information 1602, it is decided that the image data that has been retained in advance by the extended application 204 is to be used to display the preview image. By performing control in this way, it is possible to appropriately perform the display control of a preview image depending on whether or not the scan apparatus 102 supports the preview function.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-067463, filed on Apr. 18, 2024, which is hereby incorporated by reference herein in its entirety.

What is claimed is:

1. A non-transitory computer-readable storage medium storing a program that supports a general purpose program that outputs an instruction capable of being commonly interpreted by scanners from a plurality of manufacturers, the program causing a computer to:
display a setting screen that accepts a setting for a sharpness adjustment of an image that has been read; and
output a command for causing the scanner execute a scan processing in accordance with the setting that has been accepted on the setting screen.

2. The non-transitory computer-readable storage medium according to claim 1, wherein
on the setting screen, a setting value indicating sharpness of image data to be generated by the scan processing is set by a user.

3. The non-transitory computer-readable storage medium according to claim 2, wherein
on the setting screen, one of a plurality of the setting values that are different is set by the user.

4. The non-transitory computer-readable storage medium according to claim 2, wherein
on the setting screen, the setting value is set for each of attributes of the image that has been read.

5. The non-transitory computer-readable storage medium according to claim 4, wherein
the attributes of the image include at least one of a text area, a photograph area, and an image area.

6. The non-transitory computer-readable storage medium according to claim 1, wherein
the program further causes the computer to:
receive image data that has been transmitted from the scanner designated by the user and has been generated in accordance with the command;
determine whether or not the scanner designated by the user supports the sharpness adjustment; and
execute, in a case of having been determined that the scanner designated by the user does not support the sharpness adjustment, the sharpness adjustment on the received image data.

7. The non-transitory computer-readable storage medium according to claim 6, wherein
the program further causes the computer to
output, in the case of having been determined that the scanner designated by the user does not support the sharpness adjustment, a command that does not include the setting that has been accepted on the setting screen.

8. The non-transitory computer-readable storage medium according to claim 1, wherein
the command is a command created by extending a function to a command conforming to a standard protocol.

9. The non-transitory computer-readable storage medium according to claim 1, wherein
the command is a command obtained by converting a command conforming to a standard protocol into a command system unique to the program.

10. The non-transitory computer-readable storage medium according to claim 1, wherein
the program further causes the computer to
output a first command conforming to a standard protocol and a second command that includes the setting that has been accepted on the setting screen.

11. The non-transitory computer-readable storage medium according to claim 1, wherein
the program further causes the computer to
add the setting that has been accepted on the setting screen to a command that has been created by the general purpose program for causing the scanner designated by the user to execute a scan processing.

12. The non-transitory computer-readable storage medium according to claim 1, wherein
setting items to be displayed on the setting screen are decided by using capability information of the scanner designated by the user.

13. The non-transitory computer-readable storage medium according to claim 1, wherein
setting items to be displayed on the setting screen are decided by using capability information of an application that runs by executing the program.

14. The non-transitory computer-readable storage medium according to claim 1, wherein
the program further causes the computer to
display a preview image by using the setting that has been accepted on the setting screen.

15. The non-transitory computer-readable storage medium according to claim 14, wherein
the preview image is displayed on the setting screen.

16. The non-transitory computer-readable storage medium according to claim 14, wherein
the preview image is displayed on a screen different from the setting screen.

17. The non-transitory computer-readable storage medium according to claim 14, wherein
the program further causes the computer to
output, in response to having received an instruction to display a preview image from the user, another command for causing the scanner to execute a scan processing for generating image data to be used for displaying the preview image.

18. The non-transitory computer-readable storage medium according to claim 17, wherein
the preview image is image data that has been generated by a scan processing executed by the scanner in accordance with the another command.

19. The non-transitory computer-readable storage medium according to claim 14, wherein
the preview image is image data that has been retained in advance in the computer and corresponds to the setting that has been accepted on the setting screen.

20. The non-transitory computer-readable storage medium according to claim 14, wherein
the program further causes the computer to,
in a case where the setting on the setting screen has been changed in a state where the preview image has been displayed, execute a sharpness adjustment using the changed setting with respect to image data that has been used to display the preview image, and display a preview image by using the image data for which the sharpness adjustment has been performed.

21. The non-transitory computer-readable storage medium according to claim 14, wherein
the program further causes the computer to
display a section that accepts an instruction to save the preview image.

22. The non-transitory computer-readable storage medium according to claim 14, wherein
the program further causes the computer to
decide whether image data that has been generated the scanner designated by the user or image data that has been retained in advance in the computer is to be used to display the preview image by using capability information of the scanner.

23. A control method for an information processing apparatus in which a program that supports a general purpose program that outputs an instruction capable of being commonly interpreted by scanners from a plurality of manufacturers has been installed,
the control method comprising:
a step of displaying, on a display unit of the information processing apparatus, a setting screen that accepts a setting for a sharpness adjustment of an image that has been read; and
a step of outputting a command for causing the scanner execute a scan processing in accordance with the setting that has been accepted on the setting screen.

24. An information processing apparatus in which a program that supports a general purpose program that outputs an instruction capable of being commonly interpreted by scanners from a plurality of manufacturers has been installed,
the information processing apparatus comprising:
at least one processor; and
a memory coupled to the processor storing instructions that, when executed by the processor, cause the processor to:
display a setting screen that accepts a setting for a sharpness adjustment of an image that has been read; and
output a command for causing the scanner execute a scan processing in accordance with the setting that has been accepted on the setting screen.
